(19) United States
(12) Patent Application Publication
(10) Pub. No.: US 2005/0114241 A1
(43) Pub. Date: May 26, 2005

(54) Employee stock plan administration systems and methods

(76) Inventors: Martin Judah Hirsch, Teaneck, NJ (US); Alex Michael Rosenthal, Syosset, NY (US); William Michael Shaffer, Glen Cove, NY (US); Murat Gurses, Paterson, NJ (US)

Correspondence Address: LESLIE GLADSTONE RESTAINO;BROWN RAYSMAN MILLSTEIN & STEINER LLP, 163 MADISON AVENUE, PO BOX 1989, MORRISTOWN, NJ, 07962-1989, US

(21) Appl. No.: 10/718,883

(22) Filed: Nov. 20, 2003

(51) Int. Cl. G06F 17/60

(52) U.S. Cl. 705/35

(57) ABSTRACT

This invention provides computer systems and methods for providing centralized employee stock plan administration. The systems and corresponding methods provide the display of an administrator's dashboard interface screen including therein an administrator's dashboard interface that provides at least one metric according to user's entitlement. The metric associated with at least one employee stock plan of a company may be processing statistics for workflow requests, processing statistics for reporting requests, plan activity for particular employee stock plans, and plan statistics for particular stock plans. The administrator's dashboard interface may provide users with features such as alerts, contact information, and market information, and may also provide access to key business functions such as an administrator's dashboard function, a participant inquiry function, a workflow function, a reporting function, a site administration function, a file exchange function, a client profile function, and an events calendar function.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

The present invention generally relates to employee stock plan administration. Particularly, the present invention relates to computer systems and methods, which provide automated employee stock plan administration and management functionality.

A number of employers, e.g., companies, offer compensation and benefits to their employees via stock plans, such as an employee stock option plan (“ESOP”), employee stock purchase plan (“ESPP”), restricted stock agreement plan (“RSA”), etc. Stock plans provide a variety of benefits for both the employer and employee. Employers, for instance, may benefit with increased tax savings, cash flow, and productivity, and employees granted a stake in the company therewith are able to share in the company's success. An employee stock option is generally a contractual right granted to an employee or employees that give employees the option to purchase company stock during a specified period at a predetermined price. An ESPP similarly allows employees to purchase company stock, however, rather than at a predetermined price, the employee usually purchases the stock at a discounted price. Under a restricted stock agreement, the company generally grants company stock to an employee subject to specific vesting and transfer restrictions.

As attractive as the employee stock plans may be, administering the various types of stock plans and the individual contracts or agreements thereunder may prove to be a complex and burdensome endeavor particularly because each of respective plans include a number or qualifications and limitations, either contractual or regulatory, associated therewith which must be adhered to in order for the parties to attain the maximum benefit from the respective stock plans. The burden is compounded for companies conducting business on a national or international scale having a relatively large number of employees that are qualified or able to participate in the respective plans provided by the employer.

Automated systems appearing in the art, such as the Stock Option Control and Exercise System disclosed in U.S. Pat. No. 6,269,346, which is hereby incorporated herein by reference, attempt to reduce the burden associated with managing and exercising stock options. The systems and corresponding methods disclosed in the U.S. Pat. No. 6,269,346, however, have numerous shortcomings, including limited general applicability for administering or managing plurality types of stock plans. There is therefore a need for systems and methods which provide greater efficiency with respect to administering a plurality of employee stock plans.

### SUMMARY OF THE INVENTION

In accordance with this invention, computer systems and methods are disclosed that provide centralized employee stock plan administration. In one aspect of the present invention, centralized employee stock plan administration is provided by receiving identification information from a user, determining the user's entitlement to available features based on the identification information, which entitlement may be company specific, and displaying an administrator's dashboard interface screen including therein an administrator's dashboard interface that provides various metrics that are displayed according to the user's entitlement. The metrics are generally associated with one or more employee stock plans of a company, thereby providing users with key numerical data regarding at least one employee stock plan.

In one embodiment, the metric comprises at least one of processing statistics for workflow requests, processing statistics for reporting requests, plan activity for particular employee stock plans, and plan statistics for particular stock plans. The plan activity metric may be data pertaining to at least one of the number of shares of company stock exercised, vested, expired, settled, and released. The plan statistics metric may be data pertaining to at least one of the number of active participants, outstanding grants, outstanding options, outstanding plan value, outstanding shares, and total elections. The administrator's dashboard interface may also provide the user with at least one feature selected from a group consisting alerts, contact information, and market information.

In one embodiment, the administrator's dashboard interface screen includes therein at least one of a plurality of available key business function navigation elements displayed according to user's entitlements, which allow users to access therewith key business functions. The key business function navigation elements may be displayed consistently within each of the key business function interface screens corresponding to each of the available key business functions. The key business navigation elements may allow users to access key business functions such as at least one of an administrator's dashboard function, a participant inquiry function, a workflow function, a reporting function and a site administration function.

A participant inquiry interface screen, displayed in response to a user's navigation request, e.g., to access the participant inquiry function, includes therein form elements allowing the user to specify search criteria to search for participants of at least one employee stock plan. A search result interface screen listing participants matching the user's search criteria may be displayed after receiving the search criteria from the user. The search result interface screen may include at least one navigation element therein allowing the user to access participant information for a particular participant. A participant profile interface screen may thus be displayed in response to a request for a participant profile for a particular participant. The participant profile interface screen generally providing personal information relating to the participant, and including therein navigation elements allowing a user to access at least one of administration data, comments, registration data, leave of absence data, participant plan information, and trade summaries for the selected participant.

The workflow functionality allows the user the ability to request particular administration tasks such as changing a participant's status to “terminated” or run a particular report. The user may attach files to the request and may ask to be notified via email once the task has been accomplished.

A workflow interface screen, displayed in response to a user's navigation request, provides a status summary for workflow requests. The workflow interface screen may include therein form elements allowing a user to specify search criteria to search for workflow requests. A search result interface screen listing workflow requests matching the user's search criteria may thus be displayed in response the receipt of the user's search criteria. The search result interface screen may include at least one navigation element therein allowing the user to access a case summary for a particular workflow request and, in one embodiment, may also provide a status summary for workflow requests submitted by all users assigned a specific role.

The workflow interface screen may also include form elements therein allowing a user to submit a particular type of a new workflow request. A new workflow request interface screen particular to the type of workflow request may be displayed in response to receipt of a new workflow request. The workflow request interface screen preferably includes form elements therein allowing the user to specify details of the request. In one embodiment, the workflow interface screen includes therein a participant ID form element requiring the user to input a participant's identification number in order to initiate a new workflow request for a participant. The form elements included in the new workflow request interface screen may then be automatically populated based on the participant's identification number. The particular type of new workflow requests may be any one selected from a group consisting of a general change request for a participant, a request for a participant demographic change, a grant change request, a request to indicate participant termination, a request for a participant tax profile change, a request for an exercise revision, a request to block users from the system, and a request to change insider status. The workflow interface screen may also include therein at least one navigation element associated with a particular workflow requests listed therein allowing the user to request a workflow case summary.

A plan reporting interface screen, displayed in response to a user's navigation request, allows the user to request a report based on at least one of user defined criteria and a report template of a plurality of available templates, and allowing the user to view reports. The plan reporting interface screen may include therein navigation elements allowing a user to navigate to an interface screen selected from a group consisting of a run report interface screen allowing a user to request a report therewith, a report queue interface screen proving a list of active, pending and scheduled, reports, and a finished report interface screen listing reports that the user is entitled to view, the finished report interface screen including navigation elements therein allowing the user to request an action with respect to the listed reports.

### BRIEF DESCRIPTION OF THE FIGURES

The invention is illustrated in the figures of the accompanying drawings, which are meant to be exemplary and not limiting, in which like references refer to like or corresponding parts, and in which:

FIG. 1 is a block diagram of a computer system for providing centralized employee stock plan administration according to one embodiment of the invention;

FIG. 2 is a block diagram of application architecture for a computer system providing centralized employee stock plan administration according to one embodiment of the invention;

FIG. 3 is a flow diagram of a method of providing centralized employee stock plan administration according to one embodiment of the invention;

FIGS. 4-5 are screen diagrams of a graphic user interface useful in providing centralized employee stock plan administration according to one embodiment of the invention;

FIG. 6 is a flow diagram of a method for proving participant inquiry functionality for centralized employee stock plan administration according to one embodiment of the invention;

FIGS. 7-23 are screen diagrams of graphic user interface screens useful in providing participant inquiry functionality for centralized employee stock plan administration according to one embodiment of the invention;

FIG. 24 is a flow diagram of a method for proving workflow functionality for centralized employee stock plan administration according to one embodiment of the invention;

FIGS. 25-35 are screen diagrams of graphic user interface screens useful in providing workflow functionality for centralized employee stock plan administration according to one embodiment of the invention;

FIG. 36 is a flow diagram of a method for proving plan reporting functionality for centralized employee stock plan administration according to one embodiment of the invention; and

FIGS. 37-45 are screen diagrams of graphic user interface screens useful in providing administration functionality for centralized employee stock plan administration according to one embodiment of the invention.

### DETAILED DESCRIPTION OF PREFERRED EMBODIMENTS

Stock plan administration is typically handled by specialists that may either be employed by the company providing stock plans or specialists that provide administration services to the company on a contractual basis. In either event, stock plan administrators must typically manage a variety of plan types for a number of plan participants. Managing may include tracking, handling stock transactions, maintaining records, generating reports, analyzing data, etc., which typically have been accomplished using a combination of manual and automated steps, and also using a plurality of securities trading and/or stock plan administration platforms. In accordance with at least one embodiment of the present invention, employee stock plan administration is facilitated by providing stock plan administrators or other users with centralized employee stock plan administration. Centralized employee stock plan administration is used herein to generally refer to systems and corresponding methods which provide users with key business functions and data on a single platform thereby providing an effective and efficient way for users to administer and manage employee stock plans. A business function generally relates to an activity performed in the course of administering employee stock plans.

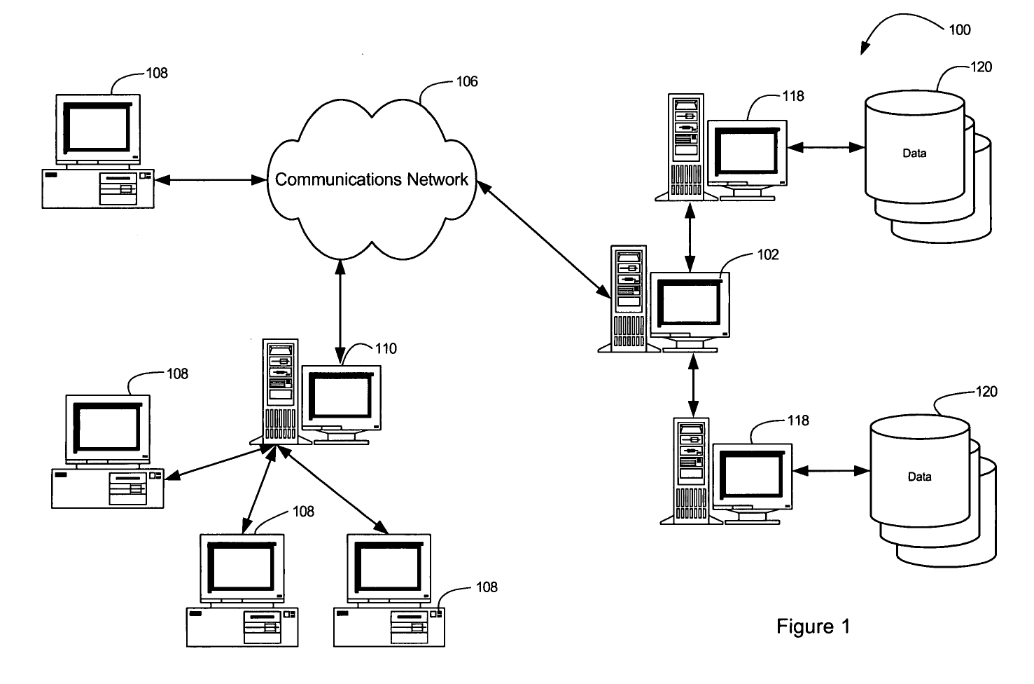

In one embodiment of the present invention, users of the system access the centralized administration functionality, as described herein, with a client interface communicatively connected to a stock plan administration system, which may be managed by a financial service firm, such as UBS Paine Webber. Referring to FIG. 1, a system for providing centralized employee stock plan administration 100 may include at least one client device 108 connected over a communication network 106 to at least one server computer, such as proxy server 102 and/or a web/application server or servers 118, having at least one database 120 associated therewith. The communications network 106 is any suitable communications link, such as a local area network (LAN), wide area network (WAN), the Internet, etc., a wireless network, or any combinations thereof. The client devices 108 may also be connected to the server computers 102, 118 via a proxy server 110. A client device is generally a multipurpose computer having a processor and memory that is capable of communicating with the server computers 102, 118 and also capable of displaying information received therefrom. A client device may therefore be a personal computer (PC), special purpose computer, a workstation, a wireless device, such as personal digital assistants (PDA), cellular phones, two-way pagers, etc.

In one embodiment, the web/application server 118 includes application programming logic that provides the backend functionality of the invention. The server computers 102, 118 include at least one program application or program module for displaying or causing to be displayed, on a client device 108, an administrator's dashboard interface screen including therein an administrator's dashboard that provides features and metrics associated with at least one employee stock plan relevant to the user logged on to the platform. A dashboard is a user interface that organizes and presents relevant information, such as employee stock plan data, in a way that is easy to view. This aspect of the invention allows users to get key information, e.g., numerical data, relevant to their daily duties, such as alerts, processing statistics, plan activity, plan statistics, contacts, market view, etc., without having to search through various platforms, applications, or interface screens. In one embodiment, the administrator dashboard screen is a homepage or a first page displayed to a user, after logging on to the system, which includes stock plan administration statistics relevant to the user for the previous (yesterday), the current (today), and the following day (tomorrow). In another embodiment, the server computers 102, 118 include at least one application or module that provides navigation and access to a plurality of interface screens and underlying applications consistently throughout the interface screens of the platform. Preferably, the server computer 102, 118 includes applications or modules that provide users with key business functions, such as administrator's dashboard, participant inquiry, workflow, reporting, site administration, file exchange, client profile, events calendar, etc., each of which are discussed in more detail below.

The client devices 108 preferably include programming therein, such as an Internet or Web browser application, for displaying a plurality of graphic user interface screens and for allowing users to communicate requests and data to the stock plan administration system, particularly to the server computers 102, 118. The server computers 102, 118 are associated with one or more databases 120 populated with information relevant for administering employee stock plans, such as information pertaining to participants, stock plans, stock prices, etc. Particular units of information relevant to administering employee stock plans, which may populate the databases 120, are discussed in more detail below in connection with the key business function applications and corresponding interface screens.

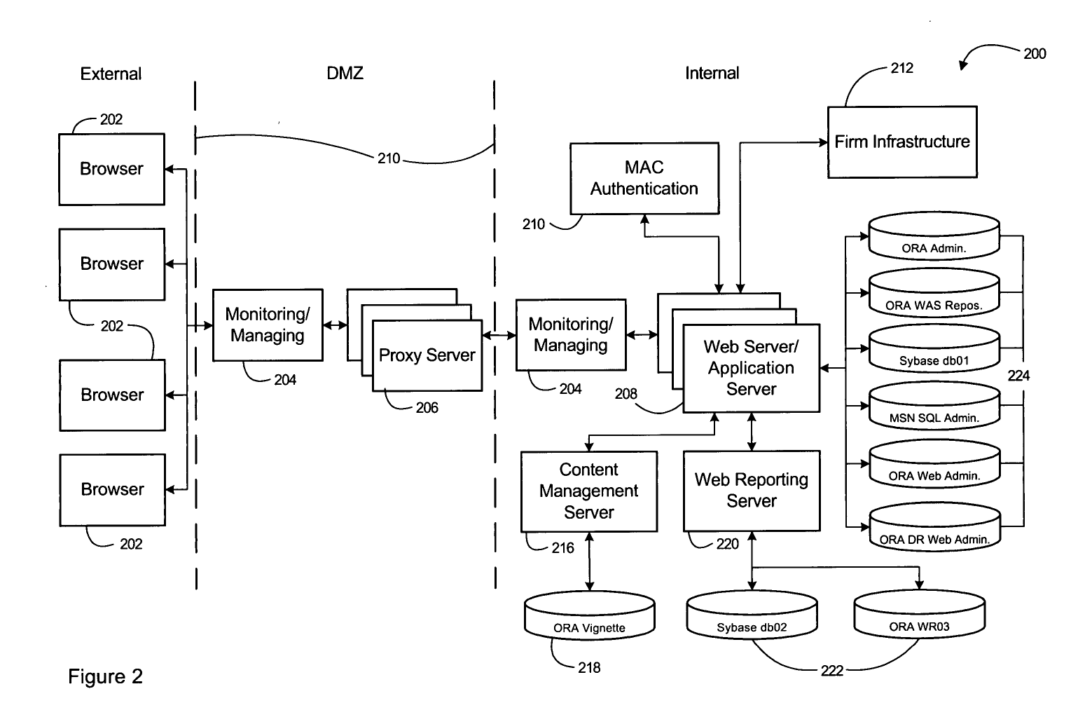

Referring to FIG. 2, in one embodiment, an application architecture for a system which provides the centralized employee stock plan administration functionality descried herein of according to one embodiment may generally be broken down into three categories of applications: external applications, applications in the demilitarized zone (“DMZ”), and internal applications. External applications are generally browser applications 202, such as an Internet or Web browser application, that allow users to communicate requests and data to the stock plan administration system and for displaying interface screens. The applications in the demilitarized zone include proxy server applications 206 and/or network monitoring/managing applications 204. The DMZ generally refers to a sub-network that may sit between firewalls 226, as shown, or off one leg of a firewall. Internal applications, may include network monitoring/managing applications 204, MAC address authentication applications 210, financial service firm infrastructure 212, at least one server application, such as a content manager server 216, a web reporting server 220, a web server and/or application server 208, and a plurality of data stores 224 associated with the respective server applications.

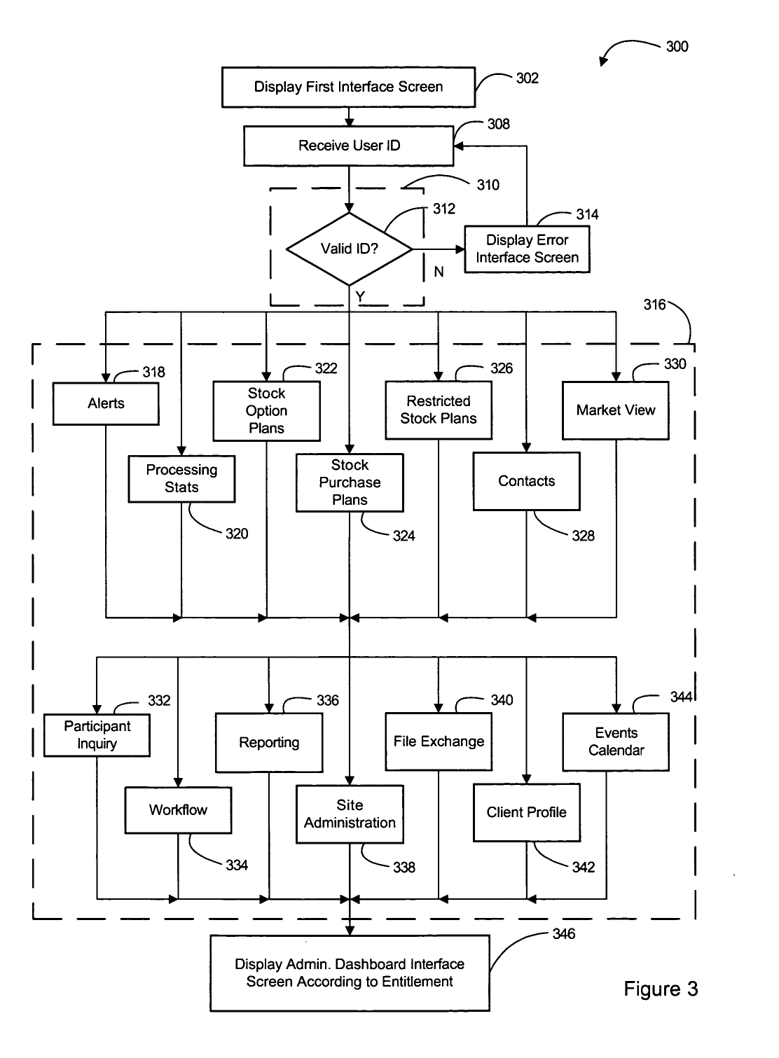

Referring to FIG. 3, a method for providing centralized employee stock plan administration 300 may begin at step 302 with displaying or causing to be displayed a first interface screen at the client device 108. The first interface screen may be, for instance, the financial service firm's home page, a login page, etc., which is displayed in response to a user request, such as by clicking an icon, hyperlink, etc. with a computer input device, such as a mouse, track ball, touch pad, keyboard, etc. and/or by specifying an Internet protocol (IP) or web address associated with the financial service firm. The first interface screen preferably includes therein navigation elements, such as hyperlinks, action buttons, clickable images, etc., which allow users to navigate to other interface screens. In one embodiment, the first interface screen, includes therein form elements, such as input fields, which allow users to communicate information identifying the user, such as a user ID and password.

If the system receives the request from the appropriate IP address, it receives the identification information from the user, step 308, and proceeds to authenticate the identification information, e.g., the user ID and password, step 310. Authentication generally denotes verifying the identity of the user that is attempting to access the system. It is understood that authentication may be accomplished in a variety of ways. In one embodiment, authentication includes comparing the identification information communicated by the user with identification information for a plurality of authorized users stored in one of the databases 120 and/or data stores 224, step 312. If authentication fails, the system displays or causes to be displayed an error interface screen indicating the failed login attempt, step 314. The error interface screen may also include form elements therein which allow users to reattempt login. In one embodiment, the number of login attempts will be limited to a predefined number, such as 3, 4, 5, etc. In the event the predefined number of login attempts have been exhausted, the error interface screen is displayed without the form elements therein.

If at step 312 authentication is satisfied, in one embodiment, the system determines the user's entitlements to available features, step 316. The system, for instance, may determine whether the user is entitled to the relevant metrics provided via an administrator's dashboard interface screen, such as entitlement to alerts 318, processing statistics 320, plan activity and plan statistics for ESOP 322, ESPP 324, and RSA 326 plans, contacts 328, e.g., contact information, and market view 330, e.g., market information. In one embodiment, all users are entitled to the market view feature. The system may also determine entitlement to key business functions, such as entitlement to participant inquiry 332, workflow 334, reporting 336, site administration 338, file exchange 340, client profile 342, and events calendar 344. For users that manage or administer stock plans for a plurality of companies, the level or degree of entitlement may be company specific. For instance, the user may be entitled to view plan activity and processing statistics for company A while only being entitled to plan activity for company B. Entitlement may be determined by accessing an entitlement database that includes data regarding entitlements to particular features, metrics, functions, etc. for particular users. The system may also determine row and column entitlement. With regard to row entitlement, the system generally determines and limits access to data for particular participant, and with regard to column entitlement, the system determines and limits access to particular types of data, such as confidential or sensitive participant information. Participant data and/or particular types of data may be filtered and thereby not presented to the user based on one of a plurality of filter criteria, such as country, location, subsidiary, name, address, phone, email address, officer description, officer code, date of birth, social security number, salary, account number or officer class. The administrator's dashboard interface screen may then be displayed or caused to be displayed according to the user's entitlements regarding employee stock plans of a first company, step 346.

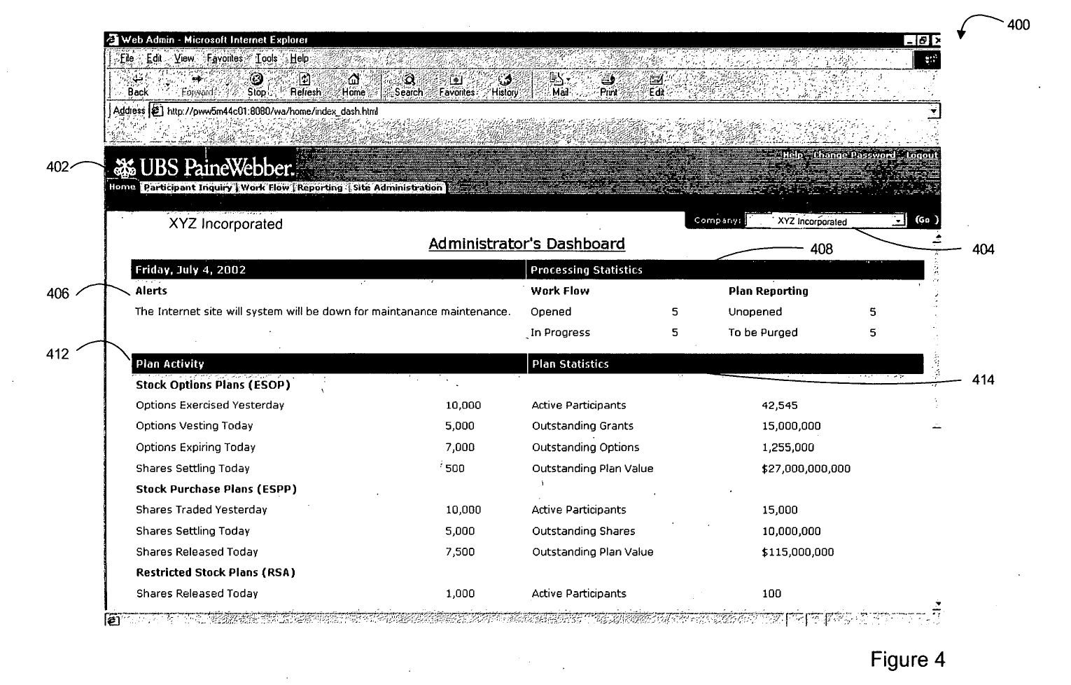

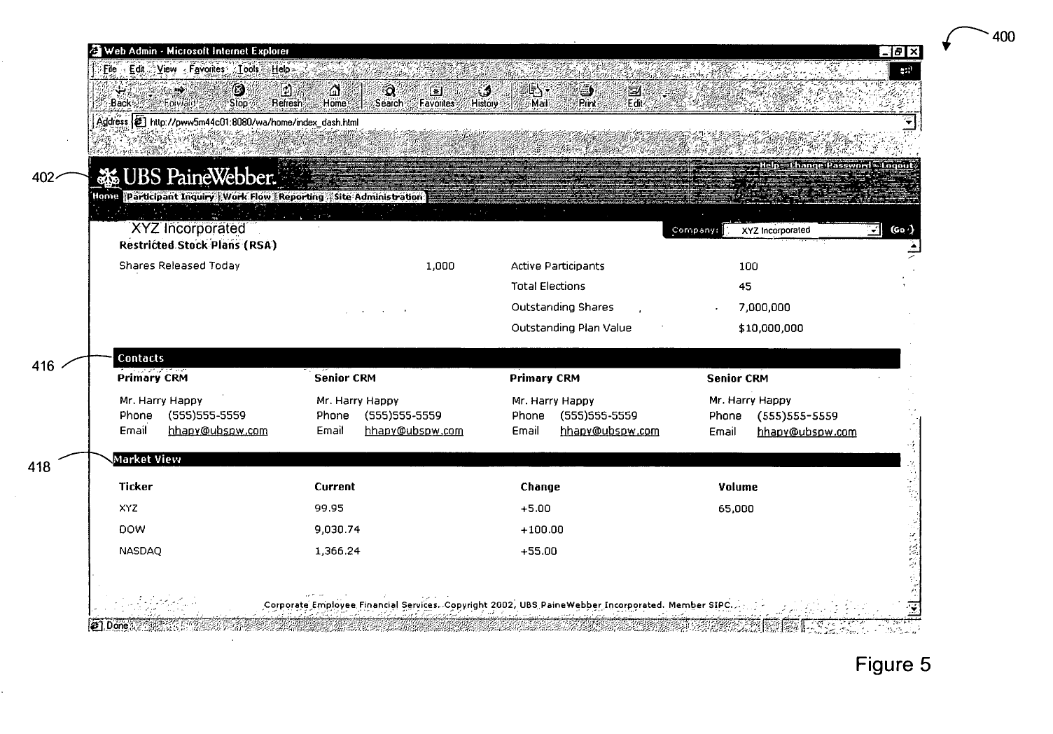

Referring to FIGS. 4 and 5, a graphic user interface useful in providing centralized employee stock plan administration, according to one embodiment, such as an administrator's dashboard interface screen 400, includes an administrator's interface including relevant metrics and features for the user logged on to the system, such as alerts 406, processing statistics 408, plan activity 412, plan statistics 414, contacts 416, and market view 418. Data displayed under the processing statistics heading generally provides a measure of the progress for workflow and plan reporting requests, which may include processing statistics for one or more companies. Data provided under the plan activity and plan statistics headings provide relevant metrics for particular employee stock option plans that the user is entitled to view. Plan activity metrics may include data regarding the number of shares of company stock exercised, vested, expired, settled, released, etc. for a particular time frame, such as for the day or for the previous day as shown. The particular time frame may be one or more days, weeks, months, etc. In one embodiment, the administrator dashboard screen includes plan activity statistics, relevant to the user, for the previous (yesterday), the current (today), and the following day (tomorrow). Plan statistics metrics may include numerical data regarding the number of active participants, outstanding grants, outstanding options, outstanding plan value, outstanding shares, total elections, etc. The administrator's dashboard interface screen may also include a company form element 404, such as a drop down list, which allows users that manage or administer stock plans for a plurality of companies to switch and correspondingly have an administrator's dashboard screen displayed according to entitlements regarding employee stock plans of another company.

In another embodiment, the administrator's dashboard interface screen includes key business function navigation elements 402 therein allowing users to access key business functions, such as an administrator's dashboard, participant inquiry, workflow, reporting, site administration, file exchange, client profile, events calendar, etc., and allowing the user to access the particular key business function interface screen associated therewith in accordance with the user's entitlements. Each key business function navigation element is preferably displayed on the administrator's dashboard interface screen 400 as an individual tab with at least one tab highlighted to indicate which of the available interface screens is being displayed. For instance, when the administrator's dashboard is being displayed, the home tab may be highlighted. The key business function navigation elements, according to one embodiment, are displayed consistently within each of the key business function interface screens. Thus, the user gains access to the key business functions by selecting or clicking a key business function navigation element which results in a navigation request communicated to the system and the system displaying or causing to be displayed a corresponding interface screen, such as an administrator's dashboard interface screen, a participant inquiry interface screen, a workflow interface screen, a reporting interface screen, a site administration interface screen, a file exchange interface screen, a client profile interface screen, or an events calendar interface screen, each including therein key business function navigation elements.

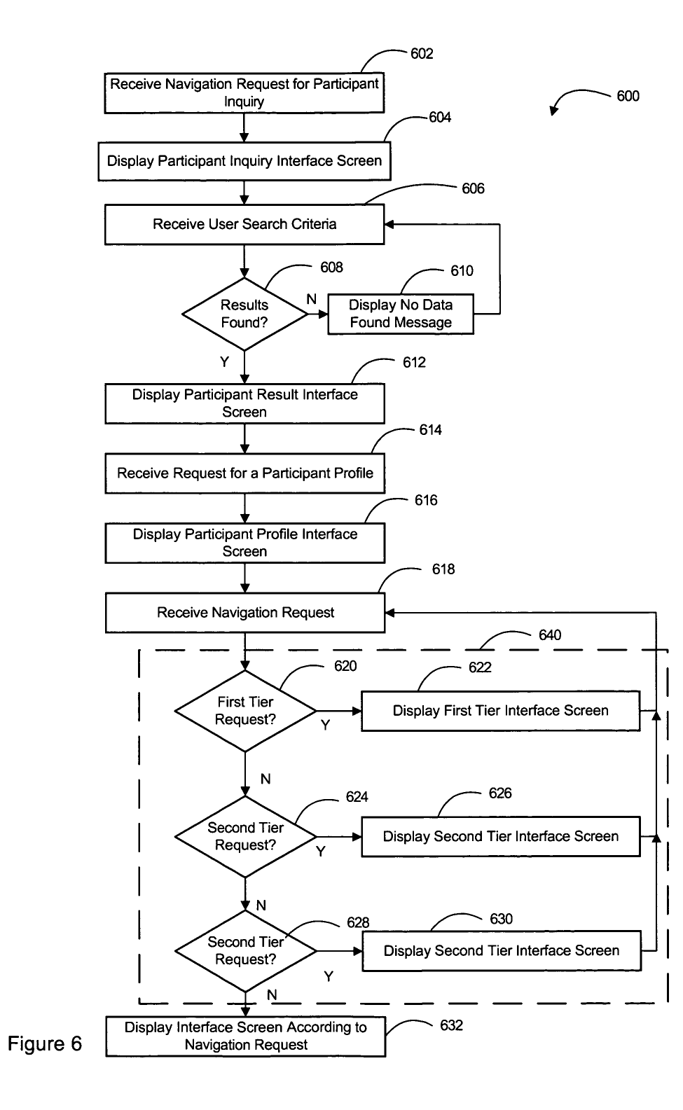

Referring to FIG. 6, a method for providing participant inquiry functionality, according to one embodiment, begins with receiving a navigation request for participant inquiry, step 602. The participant inquiry business function generally allows an entitled user of the system to search the relevant databases for particular participants and thereby access participant information, such as personal information, administration information, comments, registration information, leave of absence information, participant plan information, trade summaries, etc. The plan participant inquiry, in one embodiment, allows an entitled user to access an employee stock plan database and a brokerage database to provide a holistic picture of participants and their plans. A participant inquiry interface screen may then be displayed responsive to the user's request, step 604. The participant inquiry interface screen includes therein form elements, such as input fields, drop down lists, check boxes, radio buttons, password fields, action buttons, clickable images, etc., that allow users to specify and communicate search criteria to the system.

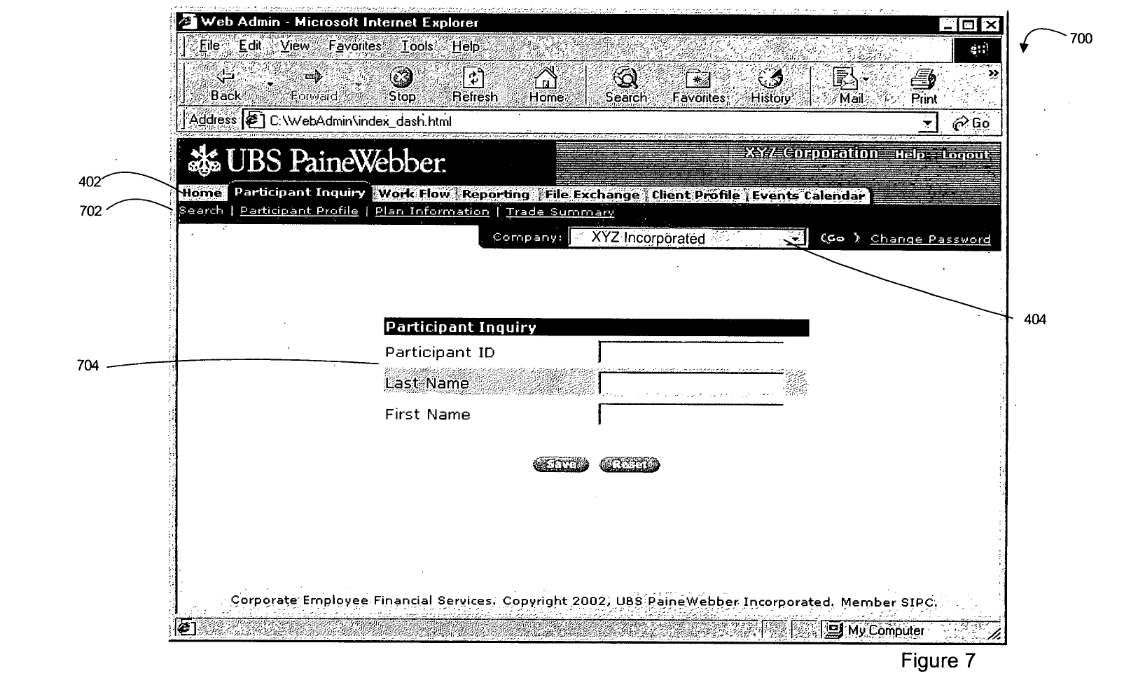

Referring to FIG. 7, a participant inquiry screen, according to one embodiment, includes input fields 704 which allow the user to specify and search the relevant databases based on a participant ID, a participant's last name, and/or a participant's first names. The participant inquiry screen may also include the key business function tabs 402 with sub-tabs 702 thereunder with at least one sub-tab highlighted to indicate which of the available interface screens in relation to the key business functions is being displayed. The sub-tabs generally allow a user to navigate to particular subcategories of the key business functions. The participant inquiry business function, for instance, may include sub-tabs for search, participant profile, plan information, and trade summary interface screens.

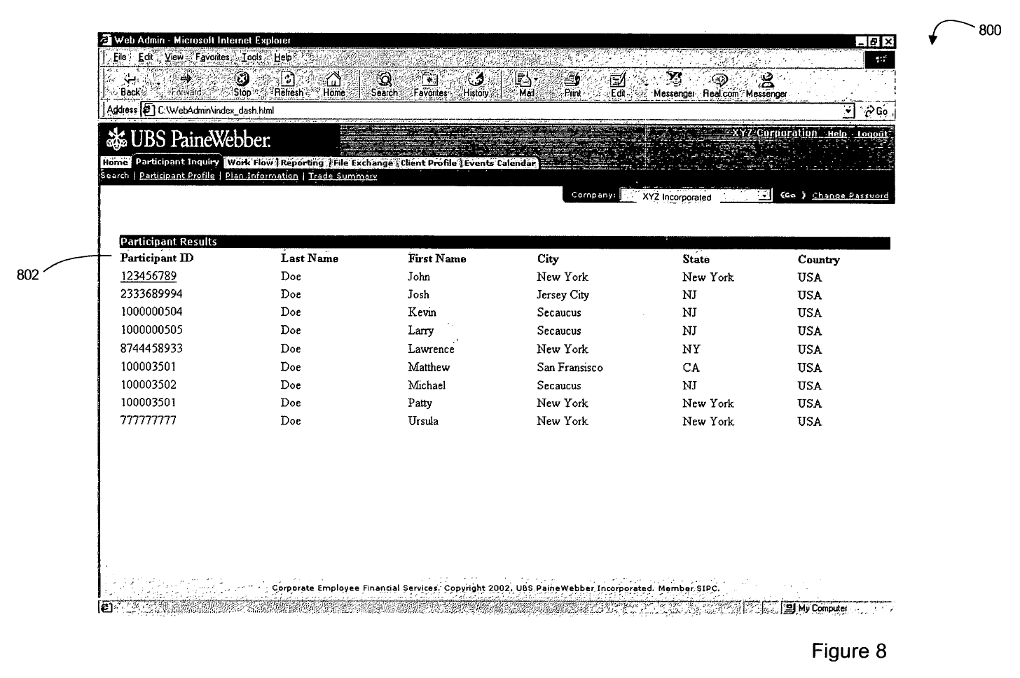

Referring back to FIG. 6, the system receives search criteria, step 606, and determines if results, e.g., participants matching the search criteria, exist. If at step 608 the system determines that there are no results, a message is communicated to the user indicating that no data was found, step 610. If however at step 608 the system determines that results exist, the system displays or causes to be displayed a participant result interface screen, step 612, listing the results of the users query. Referring to FIG. 8, a participant result interface screen, according to one embodiment, displays the results of the search criteria in a tabular format 802 and may include information on the identified participants such as the participants ID, last name, first name, city, state, and country of residence. Referring back to FIG. 6, the user may then select to view additional information on a identified participant. This may be accomplished, for instance, by the user selecting a link associated with a particular participant, which results in a request for a participant profile being received by the system, step 614, and a participant profile interface screen being displayed in response thereto, step 616.

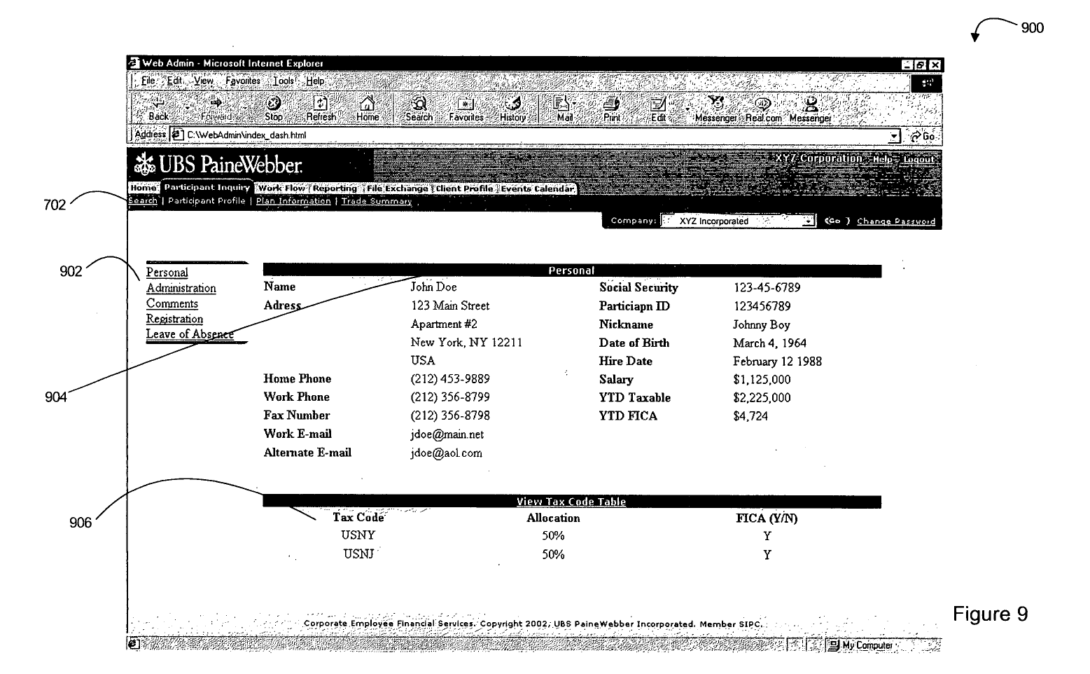

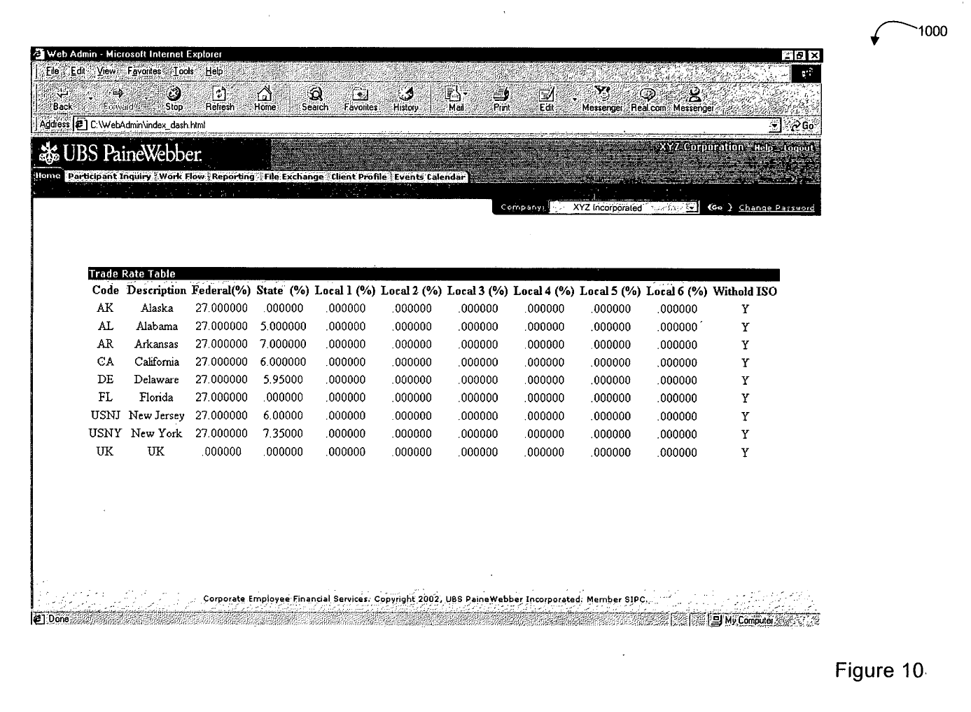

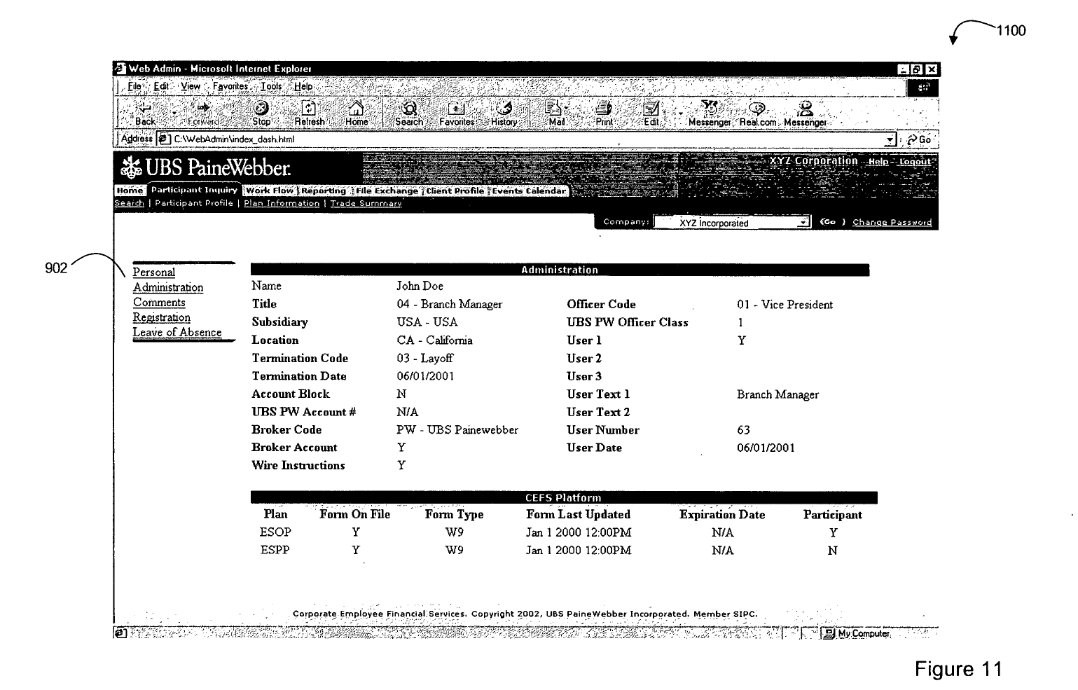

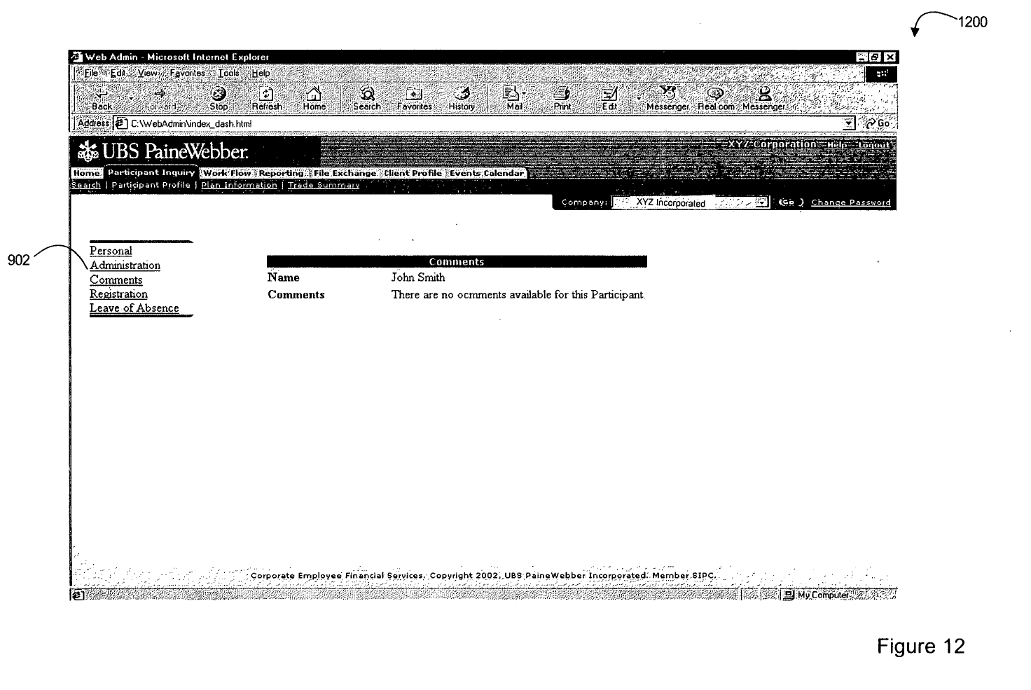

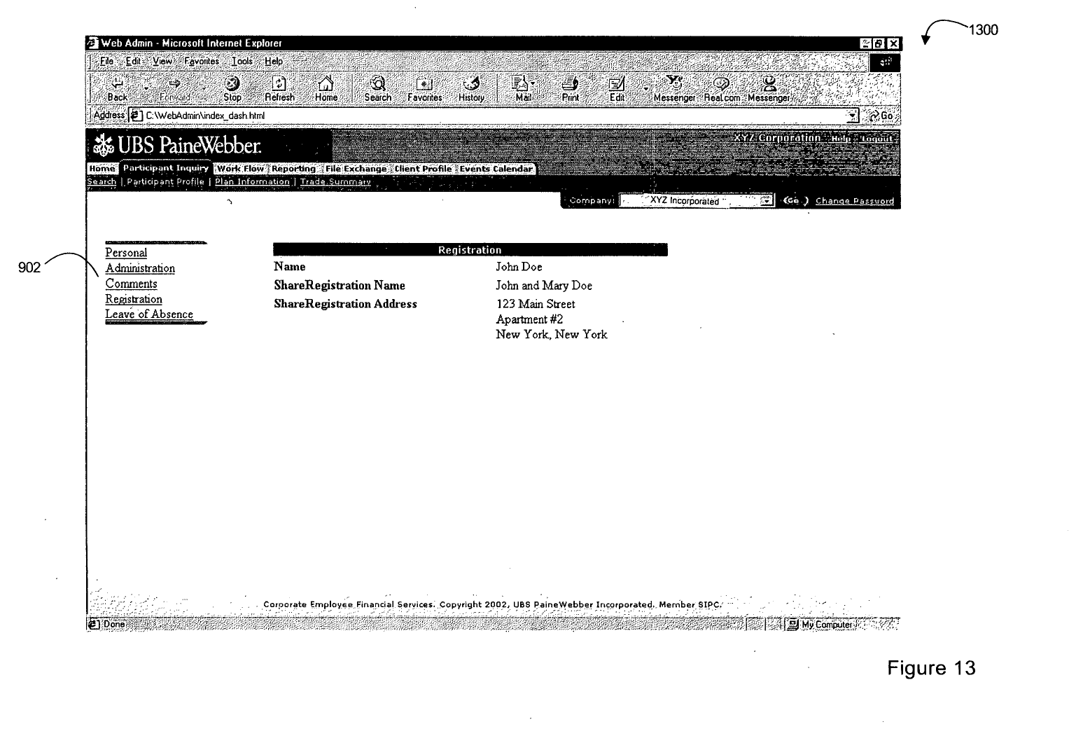

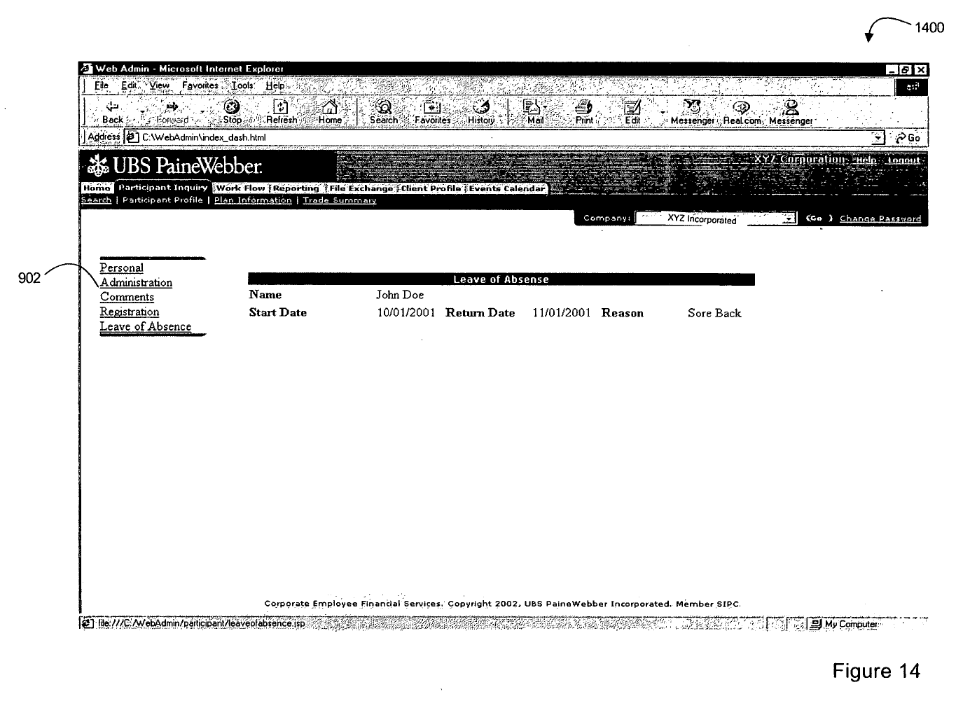

Referring to FIG. 9, a participant profile interface screen, according to one embodiment, includes the participant's personal data 904, such as a participant's name, address, phone numbers, email addresses, social security number, participant ID, nick name, date of birth, date hired, salary, year to date taxable distributions, and year to date FICA distributions, and may include tax allocation data 906 which may be viewed for cross-reference. The participant profile interface screen may also include the key business function tabs 402, sub-tabs 702, and personal data navigation elements, such as hyperlinks 902, therein enabling a user to make a first, second, and third tier request respectively therewith. The personal data navigation elements generally allow a user to view additional personal data for the particular participant, such as administration data as shown in FIG. 11, comments as shown in FIG. 12, registration data as shown in FIG. 13, and leave of absence data as shown in FIG. 14.

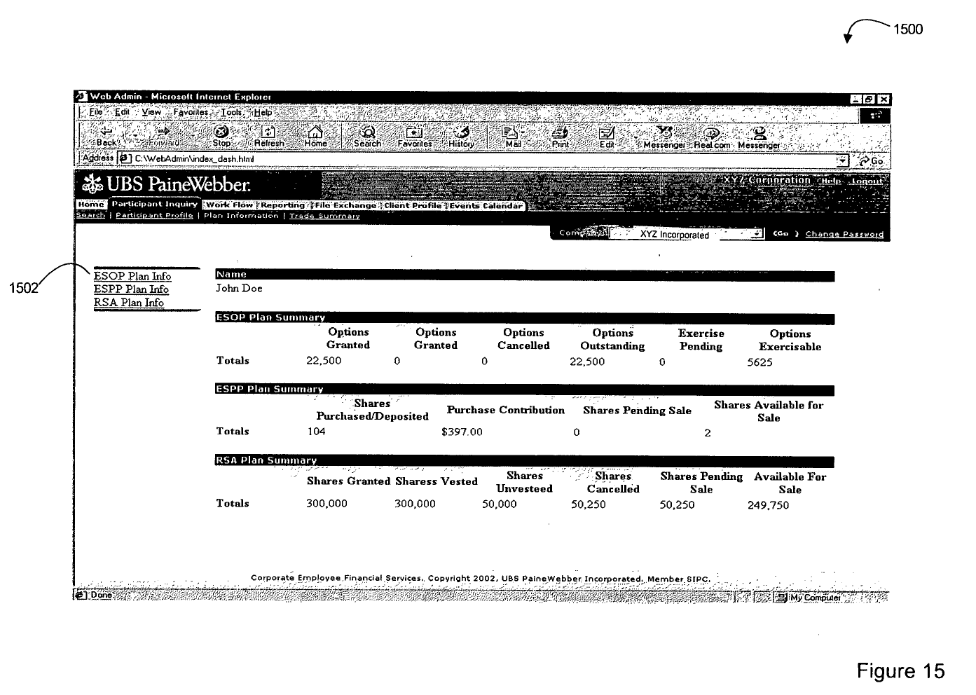

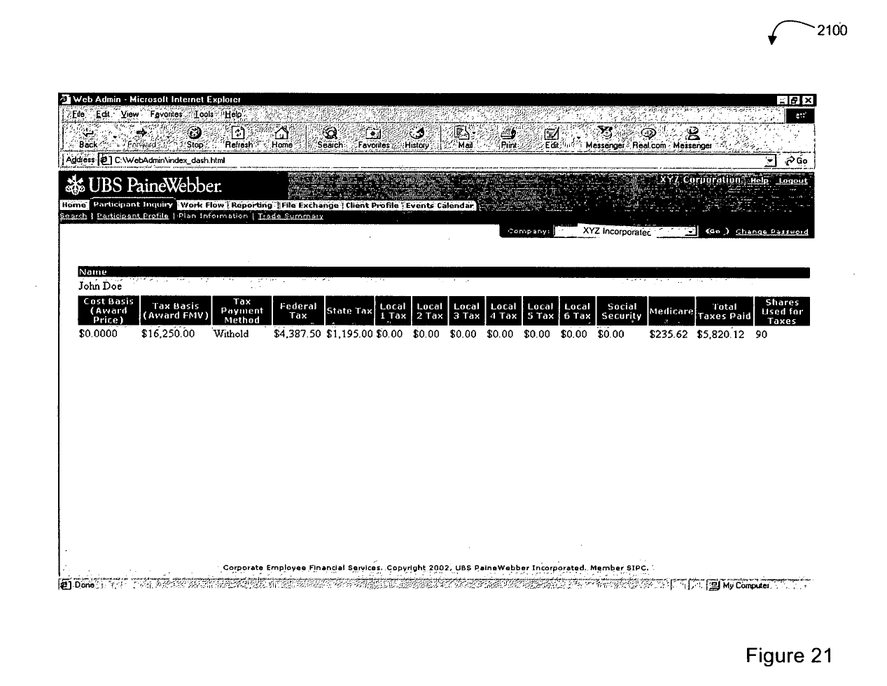

Referring back to FIG. 6, a navigation request (first, second, or third) may then be received, step 618, and a corresponding interface screen displayed at the client device, step 640. If at step 620 the navigation request is a first tier request, a first tier interface screen, e.g., an administrator's dashboard interface screen, a participant inquiry interface screen, a workflow interface screen, a reporting interface screen, a site administration interface screen, a file exchange interface screen, a client profile interface screen, or an events calendar interface screen, step 622, is caused to be displayed. If at step 624 the navigation request is a second tier request, a second tier interface screen, e.g., a participant search interface screen as shown in FIG. 7, a participant profile interface screen as shown in FIG. 9, a plan profile interface screen as shown in FIG. 15, a trade summary interface screen as shown in FIG. 21, etc., is caused to be displayed, step 626. If at step 628 the navigation request is a third tier request, a third tier interface screen, such as personal data, e.g., a participant profile interface screen, administration data, comments, registration data, and leave of absence data interface screens, is caused to be displayed at the client device, step 630. Otherwise an interface screen is displayed according to the navigation request, step 632.

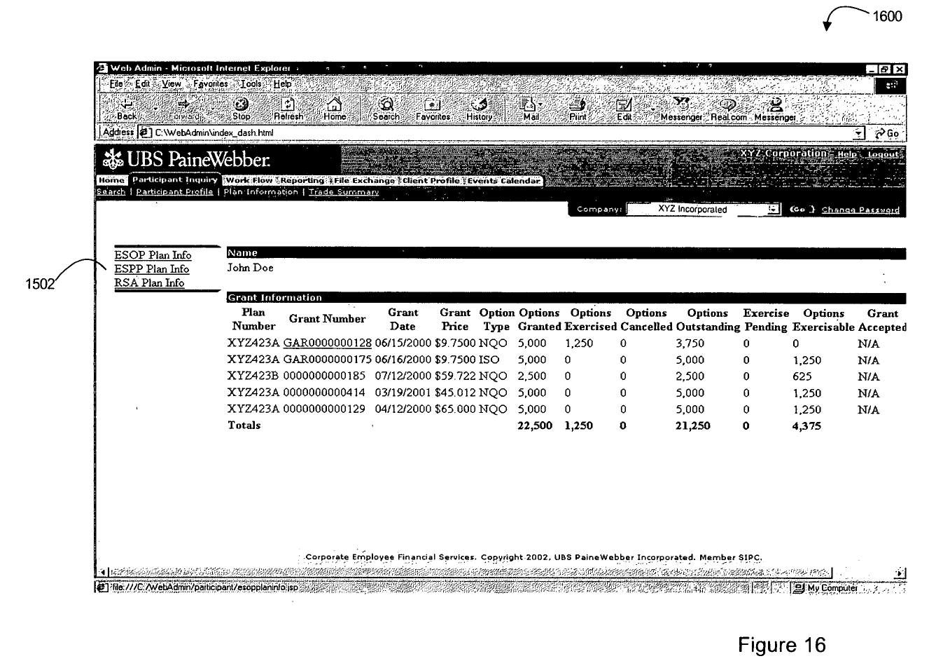

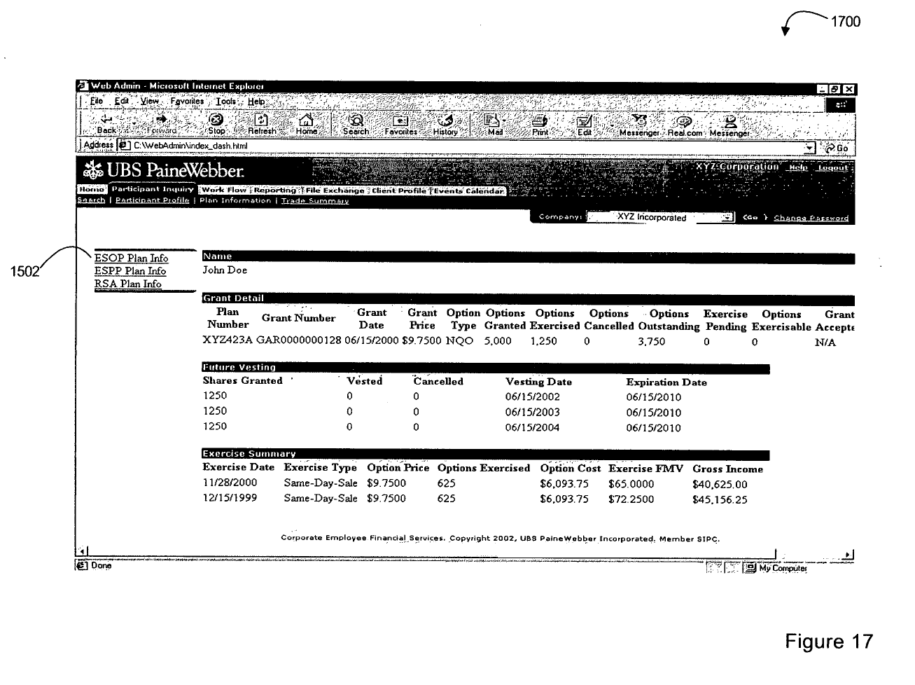

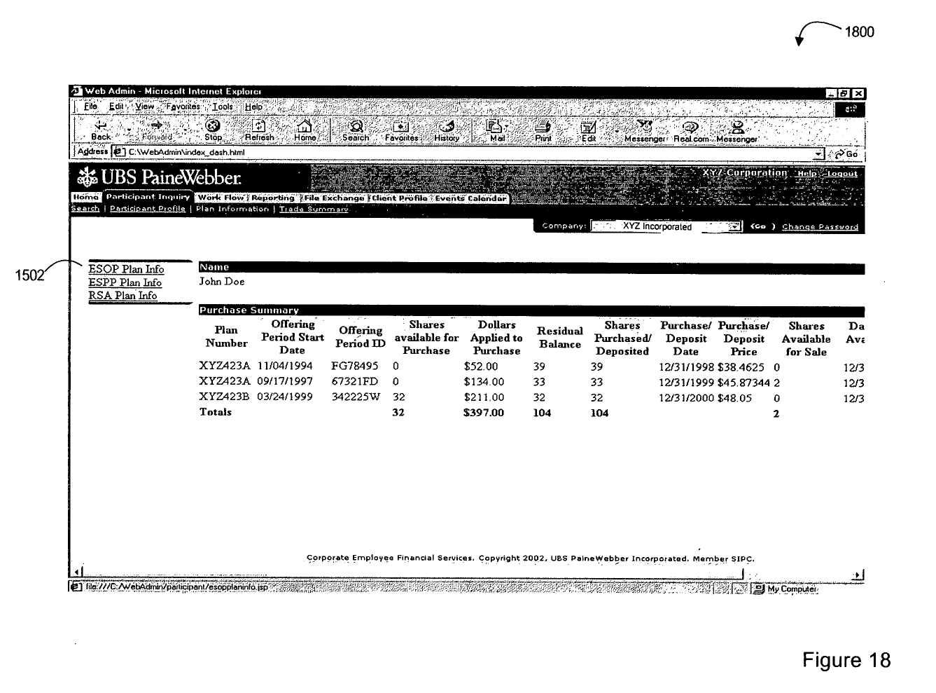

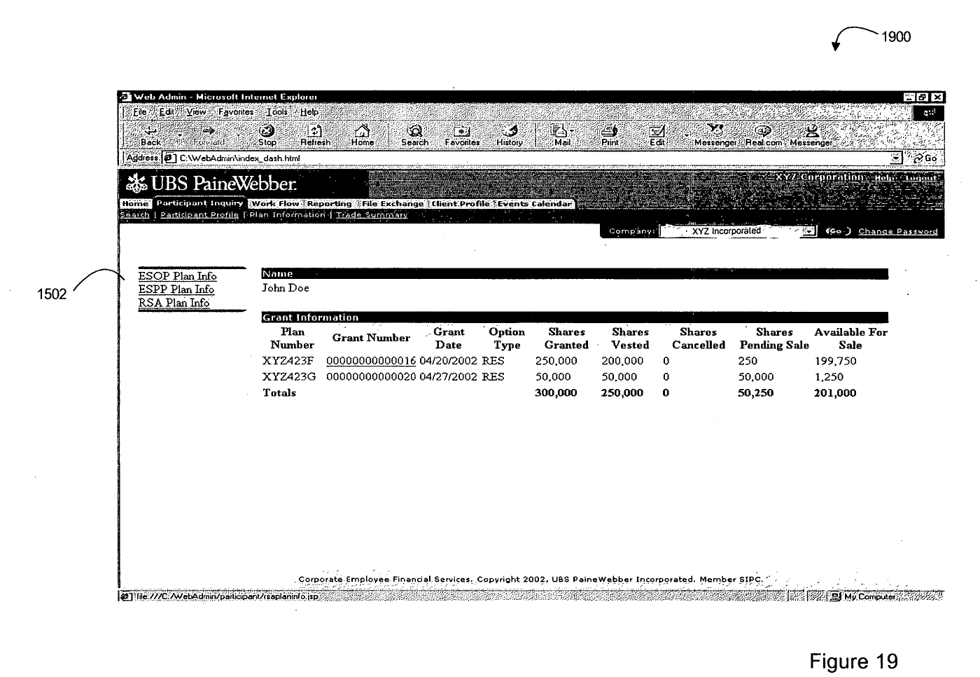

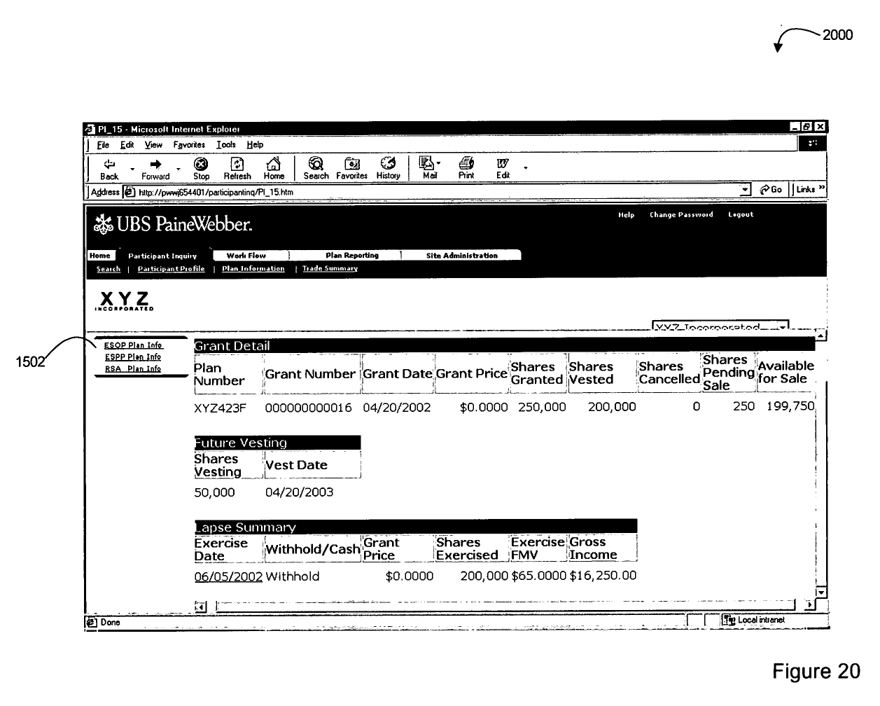

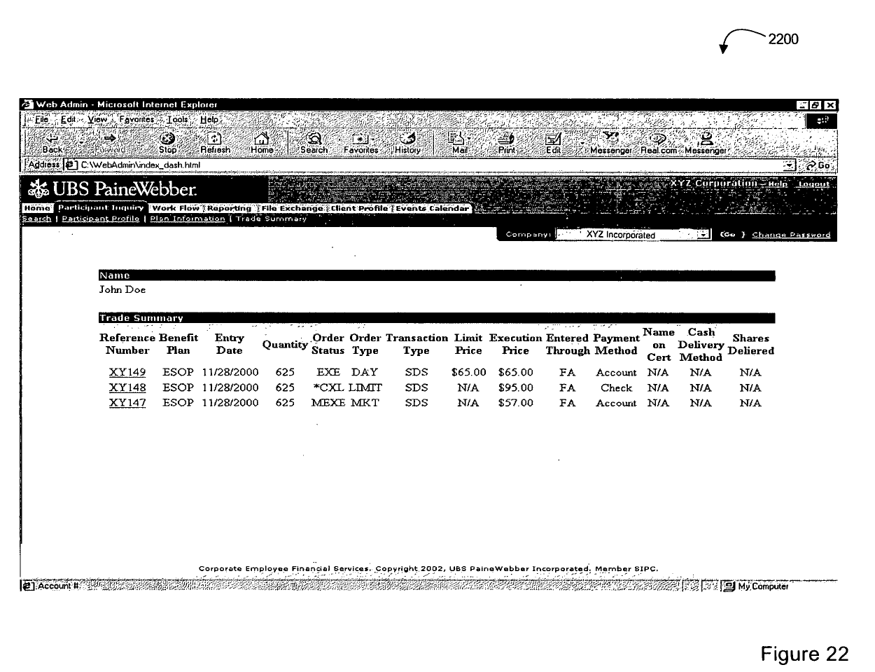

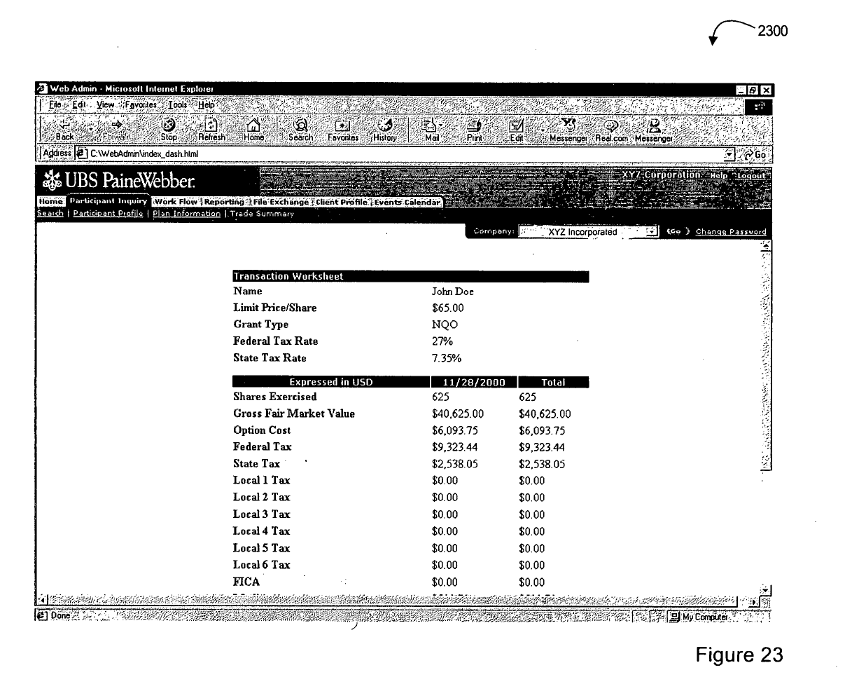

A plan profile interface screen provides general plan information for a particular participant. Referring to FIG. 15, the plan profile interface screen may include plan navigation elements 1502, such as hyperlinks, allowing a user to submit a third tier request and view therewith more detail with respect to particular plans, such as a listing of ESOP, ESPP, and RSA plan data, and may include plan data such as purchase and grant data, for the participant, as shown in FIGS. 16, 18, and 19. Each interface screen displayed in response to a third tier request may include therein hyperlinks associated with the particular items listed which allow user to view the details of specific grants or purchases, as shown in FIGS. 17 and 20-21. In one embodiment, the plan profile interface screen allows users to view a summary of the participant's plans and provides users with computed plan totals such as the number of options granted, cancelled, outstanding, pending exercise, and exercisable; the number of shares purchased, the purchase amount, shares pending sales, and shares available for sale; and shares granted, vested, unvested, cancelled, pending sale, and available for sale. A trade summary interface screen provides information regarding trades performed by the administrator for the participant and may include therein navigation elements associated with particular trades allowing a user to view specific trade details as shown in FIGS. 22-23. In one embodiment, the trade summary interface screen lists all the trades for the participant and includes therein hyperlinks allowing the user to view a transaction worksheet for a particular trade, as shown in FIG. 23.

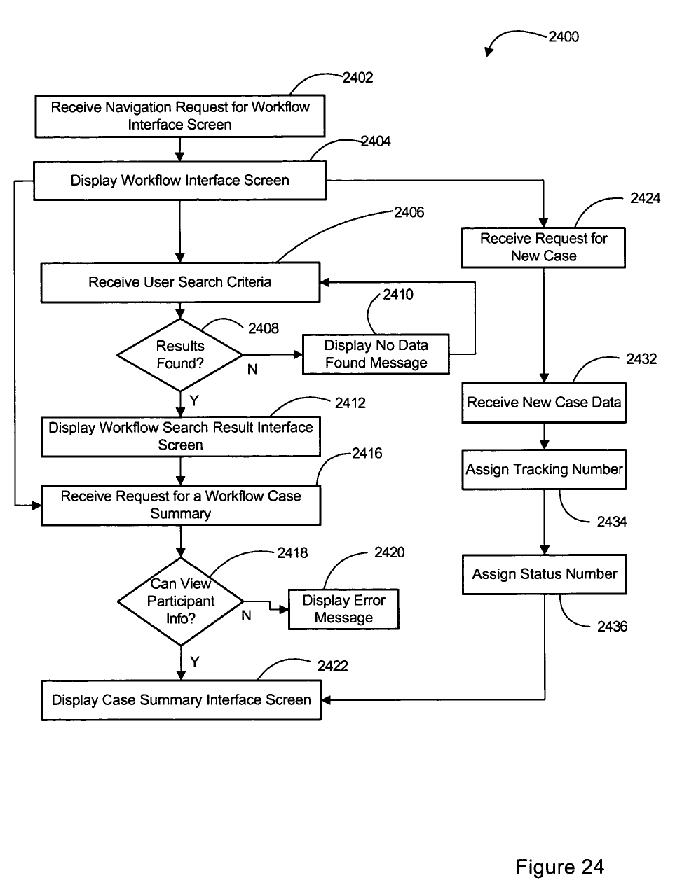

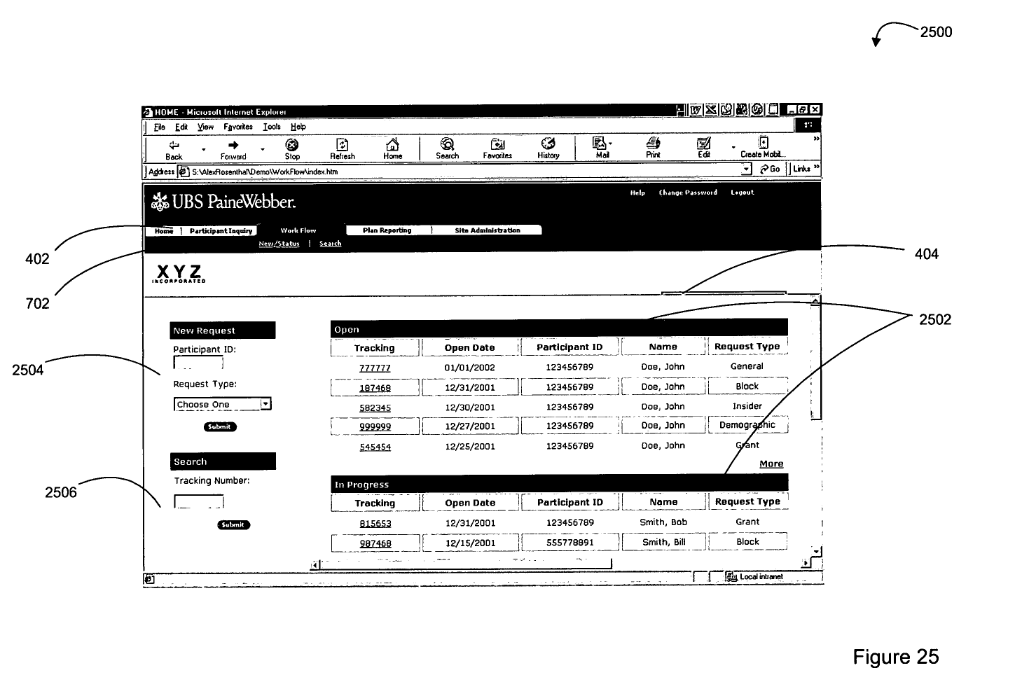

Referring to FIG. 24, a method for providing workflow functionality 2400, according to one embodiment, begins with receiving a navigation request for the display of a workflow interface screen, step 2402. The workflow business function generally allows an entitled user to submit a workflow request or workflow requests to the system administrator, e.g., the financial service firm, and view previously submitted workflow requests. The workflow requests may be saved and used to audit changes made, e.g., through workflow requests, to the relevant databases. The workflow requests, in on embodiment, would provide answers to questions regarding when, why, and what changes were made, as well as who made the changes. In response to the user request, a workflow interface screen is displayed or caused to be displayed at the client device, step 2404. A workflow interface screen, according to one embodiment, includes a summary of the status for workflow requests. As shown in FIG. 25, a plurality of workflow requests may be provided in a tabular form under relevant status headings 2505, such as open, in progress, and closed. In one embodiment, a user is able to view the status of all the workflow requests submitted by all the users assigned to a specific role and/or company. Thus, a user in a supervisory position with a plurality of users thereunder may be able to view the status of all the workflow requests for all of the supervised users.

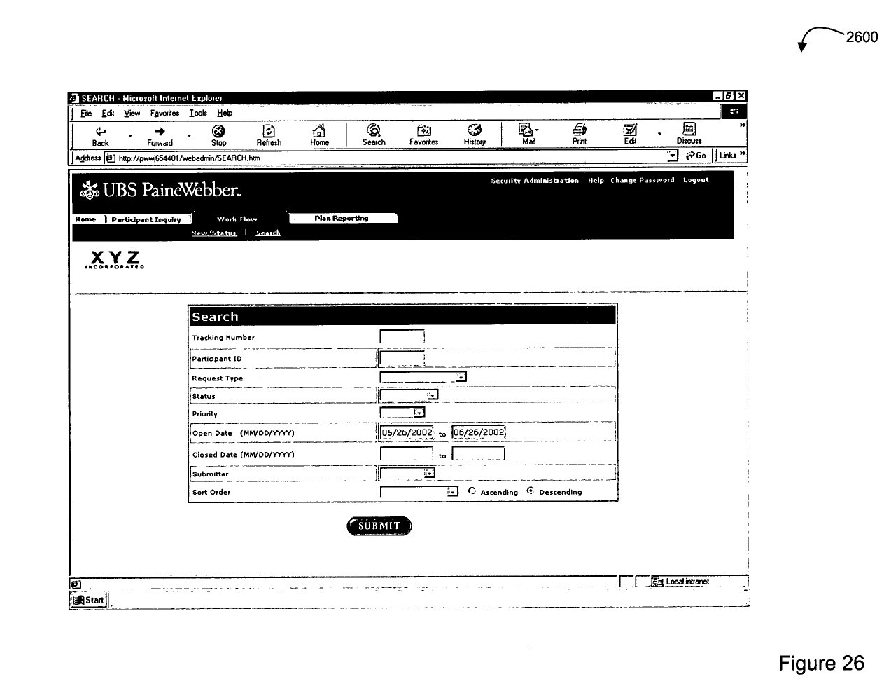

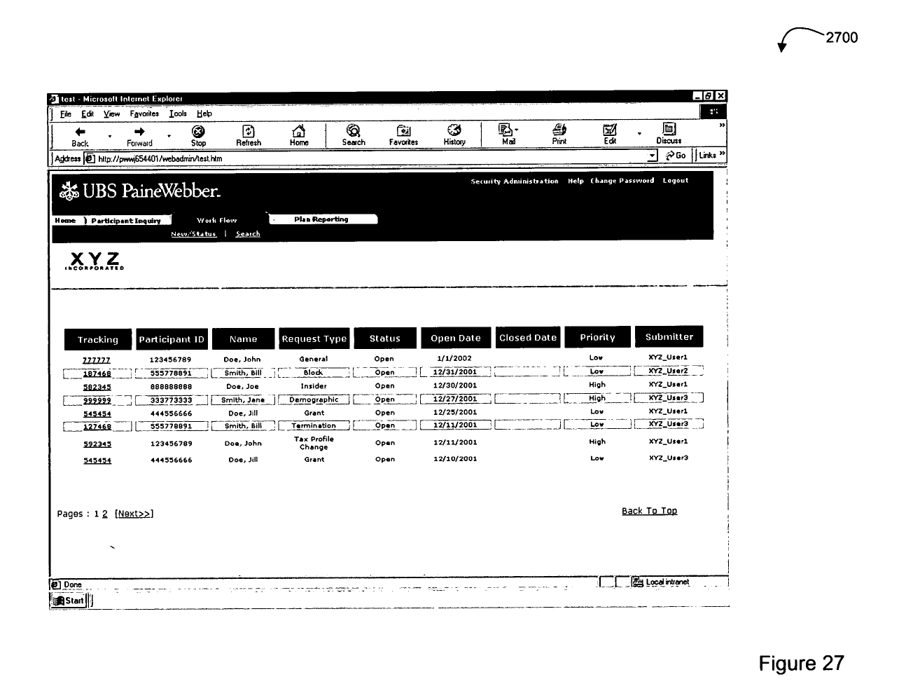

The workflow interface screen may also include form elements, such as input boxes 2506, allowing a user to search for particular requests by tracking number, or other attributes of a workflow request, such as by participant information, user (submitter) information, type of request, status of request, priority of request, open and closed dates, etc. Alternatively or in addition, the search may be facilitated with a workflow interface screen as shown in FIG. 26. In either event, search criteria is received by the system, step 2406, and if at step 2408 results matching the search criteria are found, a search result interface screen is displayed or caused to be displayed at the client device, step 2412, as shown in FIG. 27, with the matching workflow requests or cases listed therein. The search result interface screen 2700 may include navigation elements, such as hyperlinks, associated with particular workflow requests allowing a user to communicate a request for a workflow case summary, which is received by the system, step 2416, and if the user is entitled or authorized to view the participant's information, step 2418, a case summary interface screen is displayed, step 2422, in response to the request.

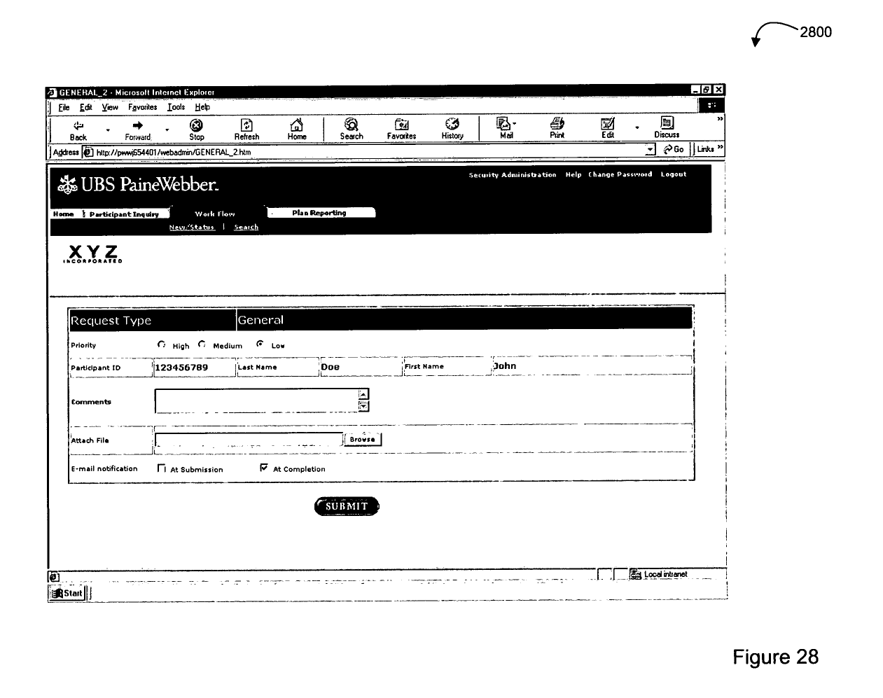

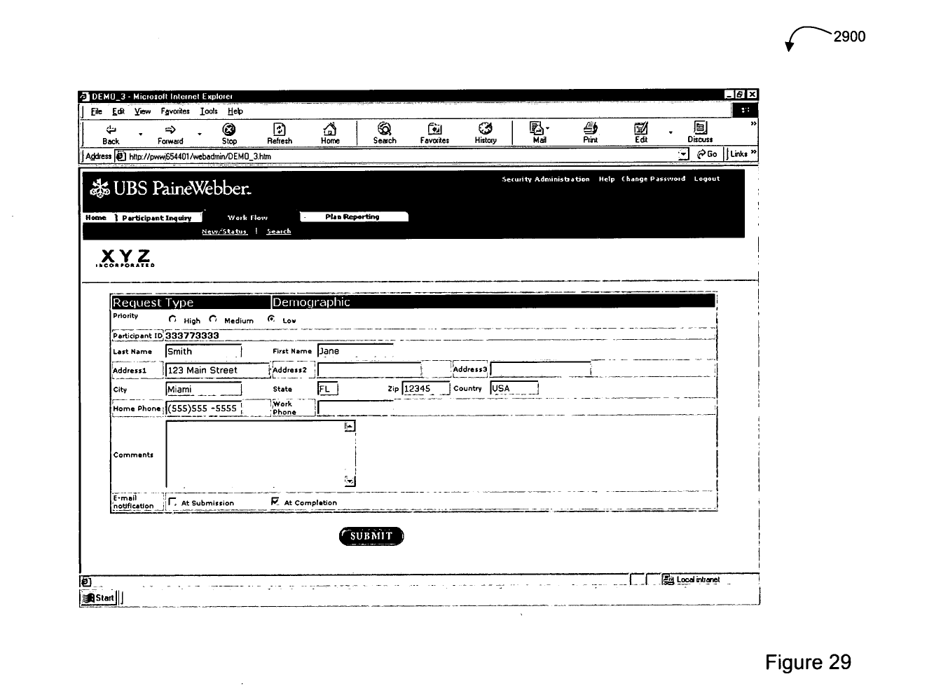

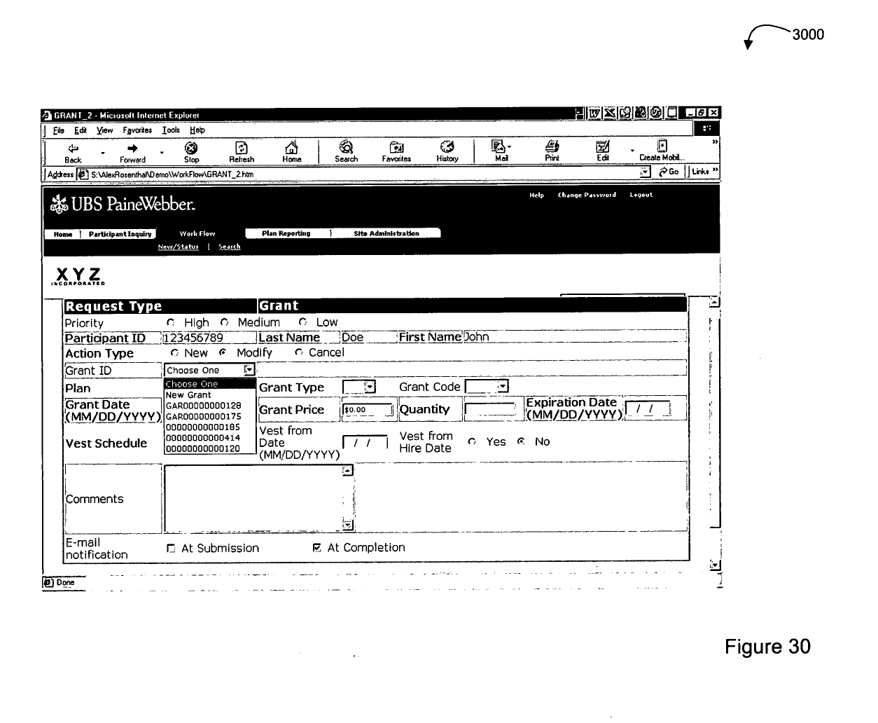

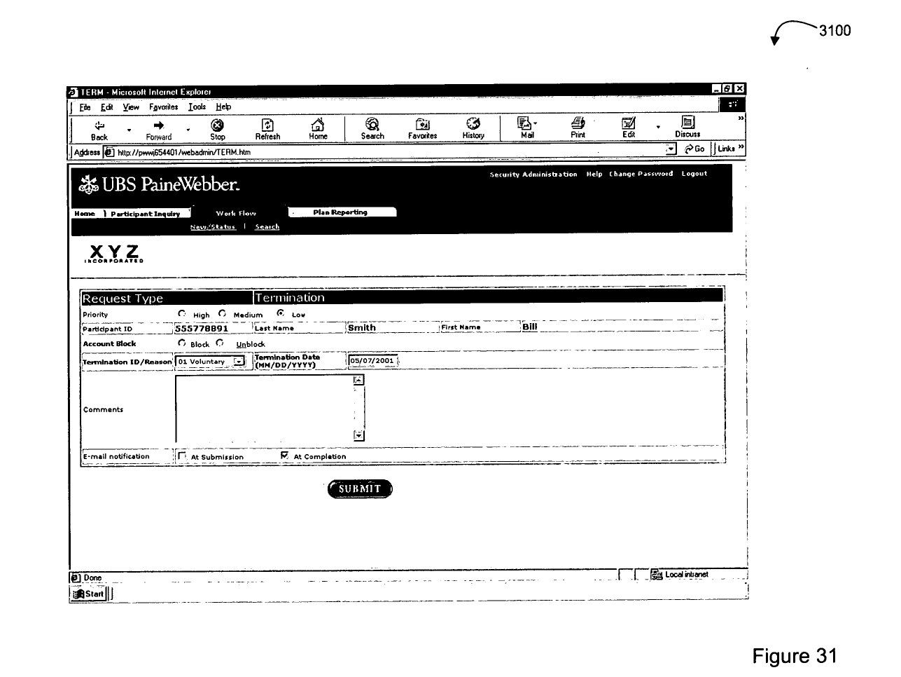

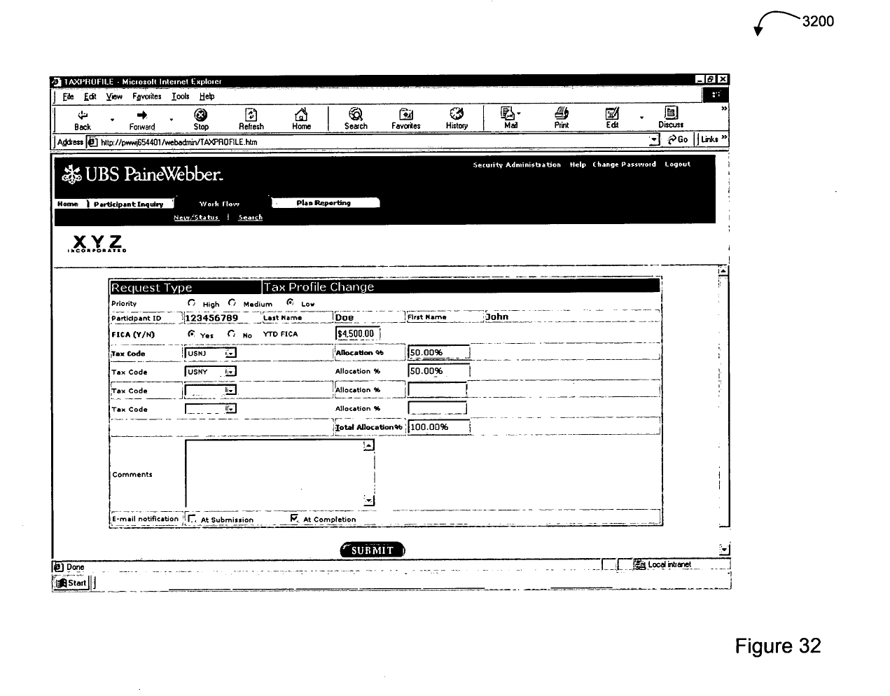

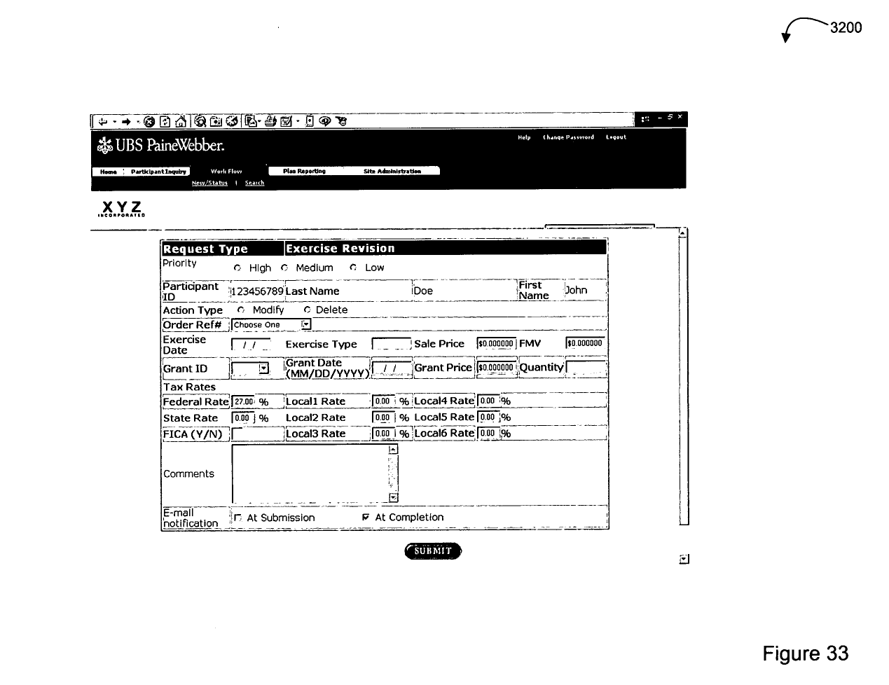

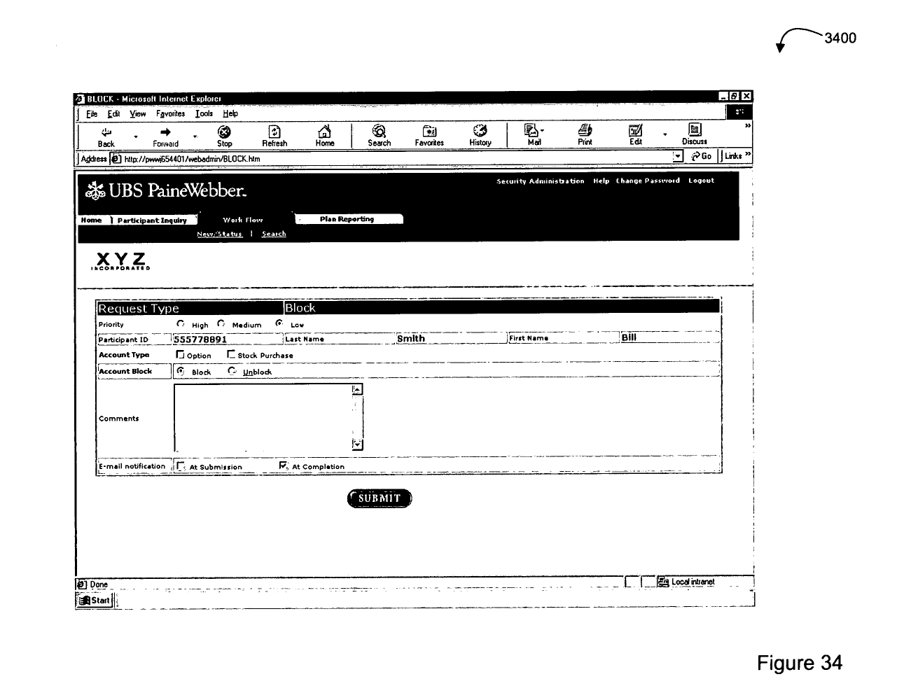

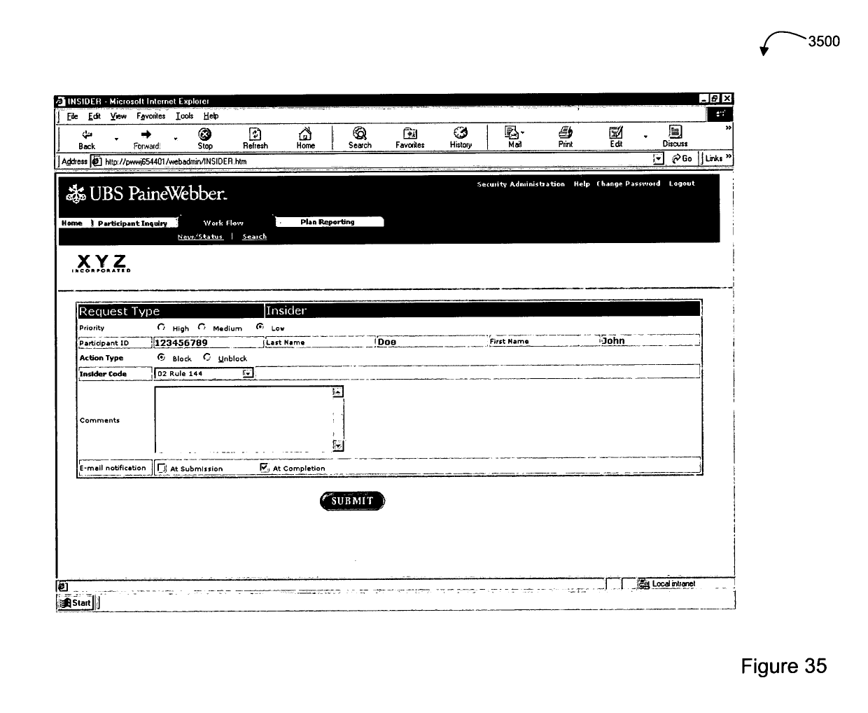

The workflow interface screen 2500 may also include form elements, such as input boxes and drop down lists 2504, allowing a user to submit or initiate a particular type of new workflow request therewith for a particular participant. In one embodiment, a participant ID number is a required data element that must be specified by the user in order to initiate a new workflow request. The participant ID may also be used by the system to retrieve participant data for the workflow request, such as the participant's name, address, relevant dates, etc., which will be used to automatically populate form elements in the new workflow request interface screens. In addition to being able to request information regarding stock transactions, such as options exercised, purchased stock, etc., users may also be able to make a general change request for a participant, a request for a participant demographic change, a grant change request, a request to indicate participant termination, a request for a participant tax profile change, a request for an exercise revision, a request to block users from the system, a request to change insider status, etc. A request for a particular type of new workflow request is received by the system, step 2424, and provided the user is entitled or authorized to submit the particular request for the participant, a new workflow request interface screen for the particular type of request is displayed at the client device, step 2430, as shown in FIGS. 28-35. The workflow request interface screen or screens include therein form elements allowing the user to specify details of the request. The request may then be communicated and received by the system, step 2432, which will assign a tracking number and an initial status to the workflow request, steps 2434, 2436. A case summary interface screen may then be displayed, step 2422, showing the details or a case summary of the workflow requests. As progress on the workflow request is accomplished, the workflow requests will be managed and audited within this application so that clients can track workflow requests during any phase of their completion. In one embodiment, the system automatically notifies the workflow requester on the closure of the request, such as by email.

The workflow request interface screen may include navigation elements, such as hyperlinks, associated with particular workflow requests listed therein, allowing a user to request a workflow case summary and to view detailed information regarding the workflow request. A request for a workflow case summary may therefore be received by the system, step 2416, and if the user has access to view the participant's information, step 2418, a case summary interface screen is displayed or caused to be displayed at the client device, step 2422.

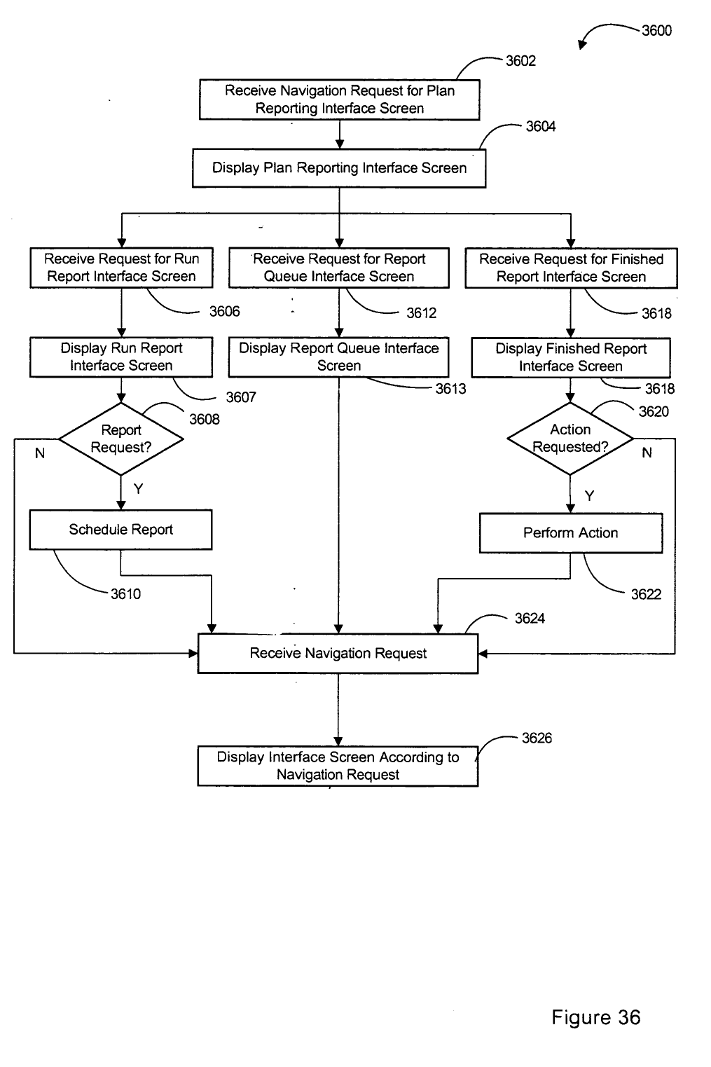

Referring to FIG. 36, a method for providing plan reporting functionality 3600, according to one embodiment, begins with receiving a navigation request for the display of a plan reporting interface screen, step 3602. The plan reporting business function generally allows an entitled user to request and view reports, such as reports regarding stock plans for one or more companies, participants, users, etc. In response to the user request, a plan reporting interface screen is displayed or caused to be displayed at the client device, step 3604. The system generally allows a user to submit a request for a custom report based on user defined criteria, and also allows a user to request a report based on a rich set of report templates, including plan and trading related report templates, that will minimize the need for customized report coding. In one embodiment, the plan reporting interface screen includes navigation elements, such as hyperlinks, allowing a user to navigate to particular interface screens, such as a run report interface screen, a report queue interface screen, and a finished report interface screen, associated with the listed items. Once a report is finished, it may be exported into Excel or PDF formst, may be published to other users or deleted.

In response to a request, step 3606, a run report interface screen is displayed or caused to be displayed, step 3607. A run report interface screen generally provides a list of products, categories, and reports that the user is entitled to execute, and allows a user to request a report therewith. If at step 3608, a report request is communicated to the system, a corresponding report is produced or scheduled to be produced, step 3610, otherwise, a user may communicate a navigation request thereby causing to be displayed an interface screen according to the navigation request. In one embodiment, the system automatically notifies the report requester, such as by email, on the closure of the request, e.g., when the report is available for viewing. In another embodiment, the user may save a search, e.g., the search report criteria, for future submission, and may further schedule reports to be run periodically.

Similarly, in response to a request, step 3612, a report request queue interface screen is displayed or caused to be displayed, step 3613. A report queue interface screen generally provides a list of active, pending, scheduled, and failed report requests for the user.

Additionally, in response to a request, step 3618, a finished report interface screen is displayed or caused to be displayed, step 3619. A finished report interface screen generally provides a list of reports that the user is entitled to view, including those submitted by the user and those run by other users that were published to the user. The finished report interface screen may also include therein elements, such as hyperlinks, allowing a user to request an action with respect to the listed reports, such as a request to view a report, save a report, delete a report, and publish a report to other users thereby ensuring that a plurality of users are provided with consistent information and reducing the need for redundant reports. If at step 3620 an action is requested, the system performs the action accordingly, step 3622.

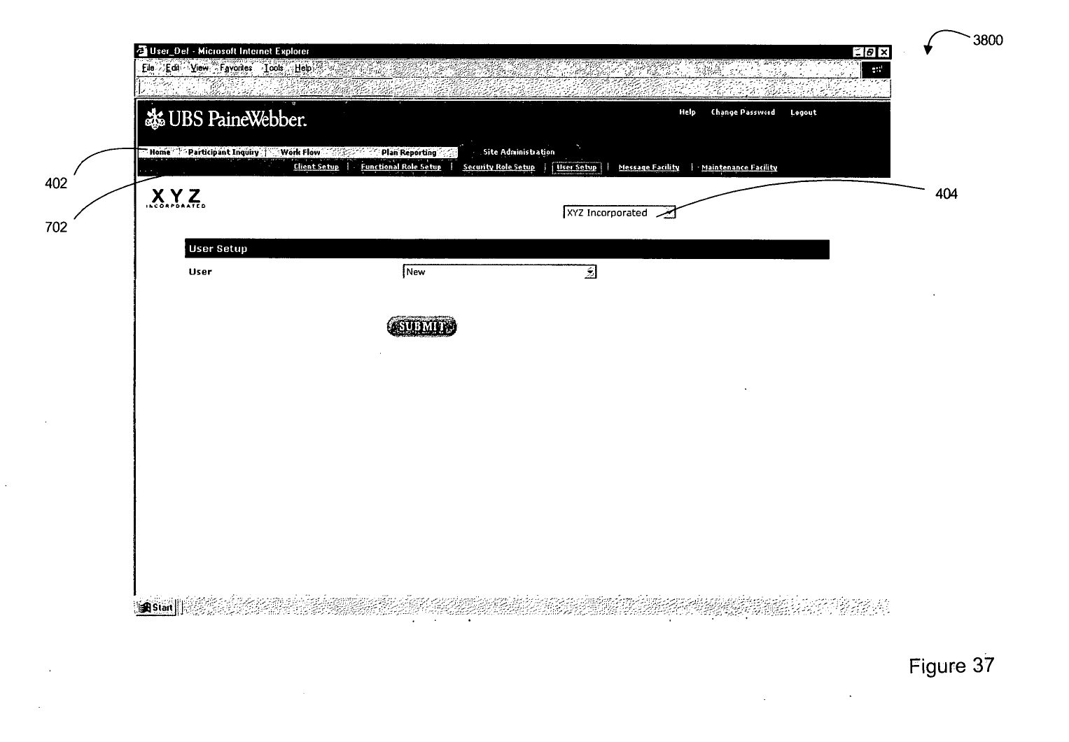

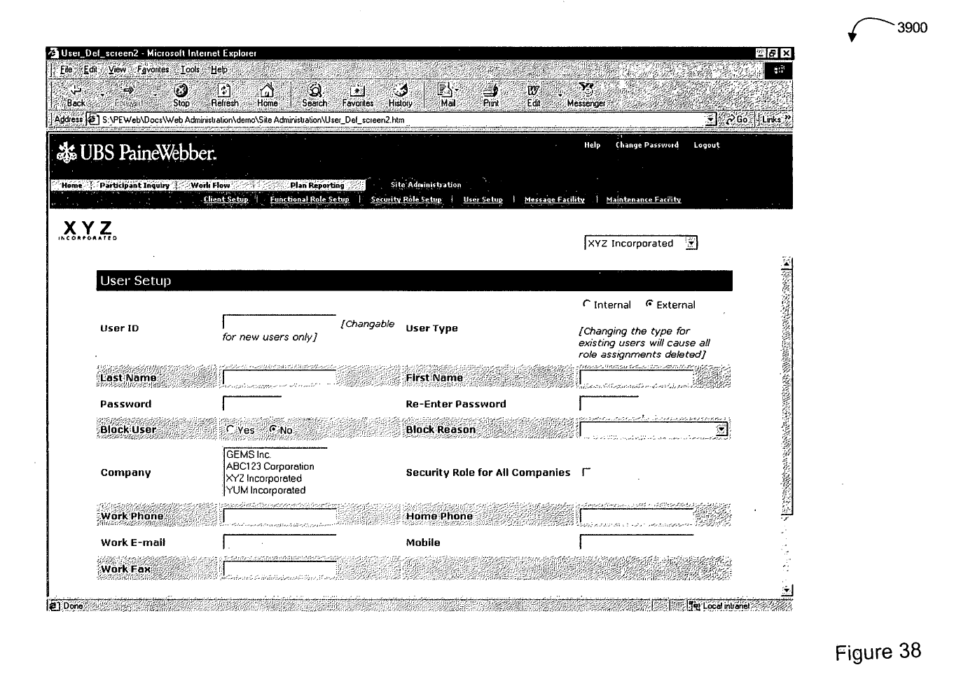

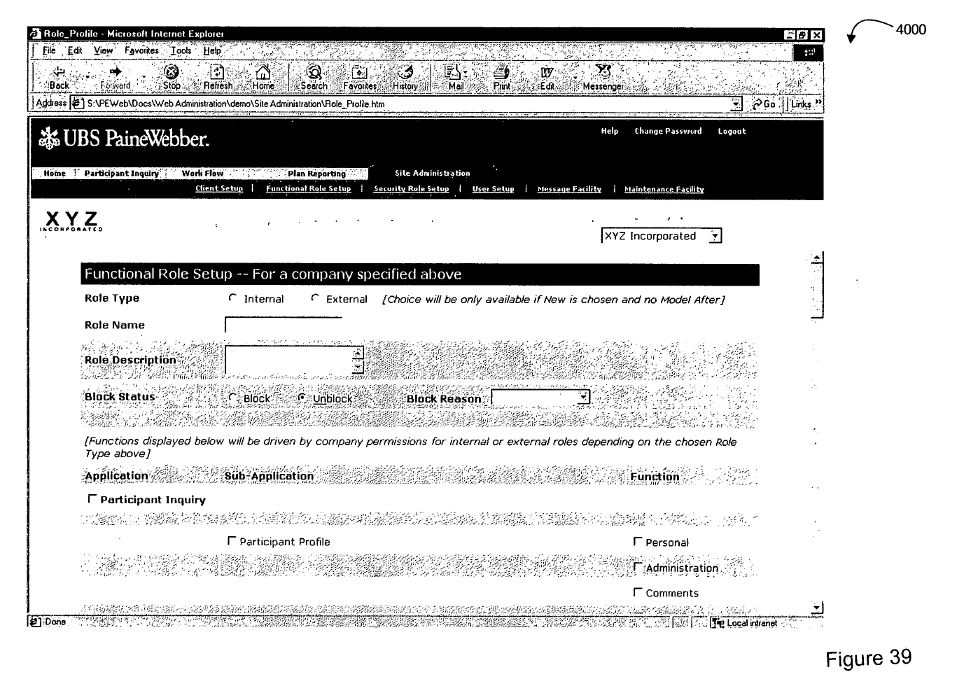

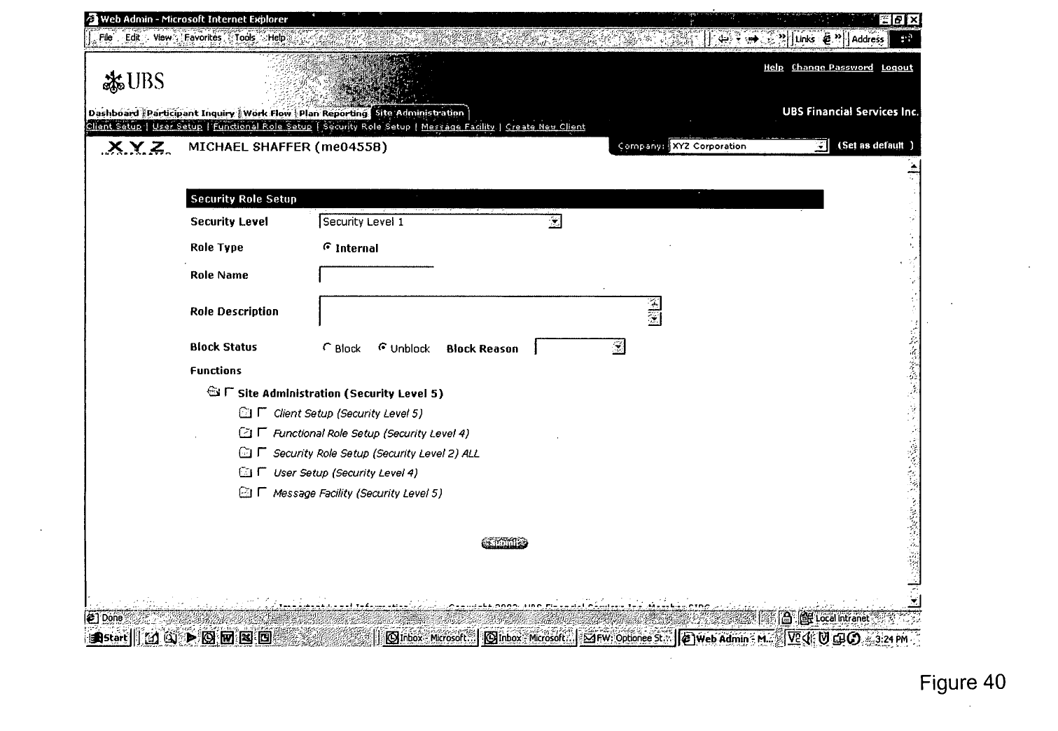

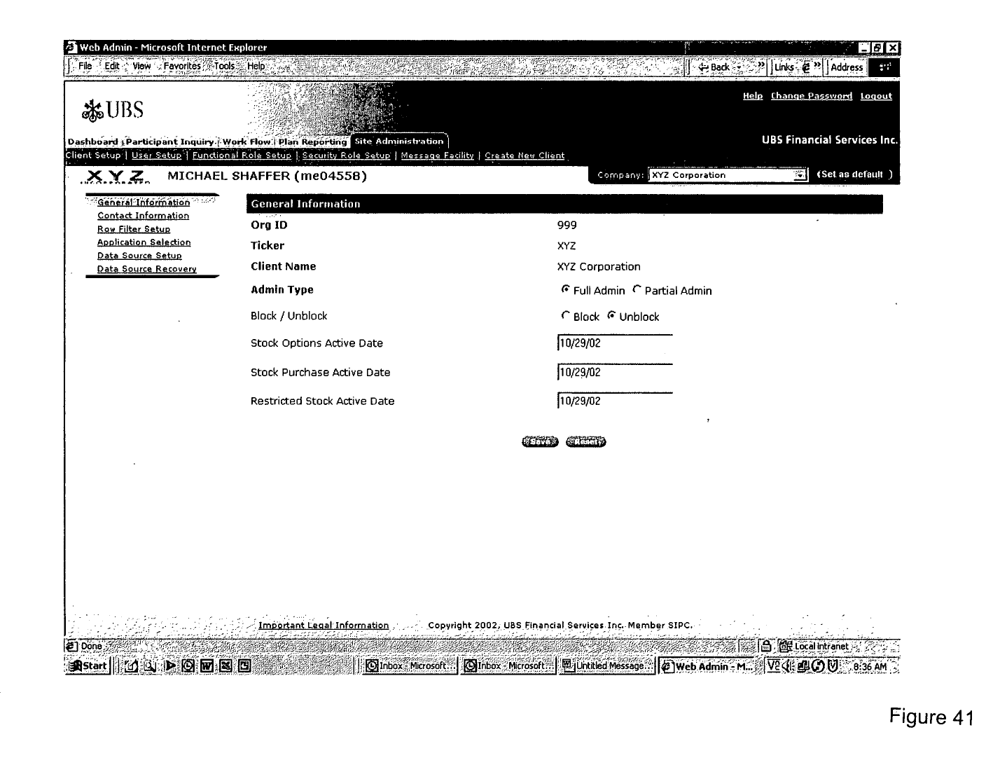

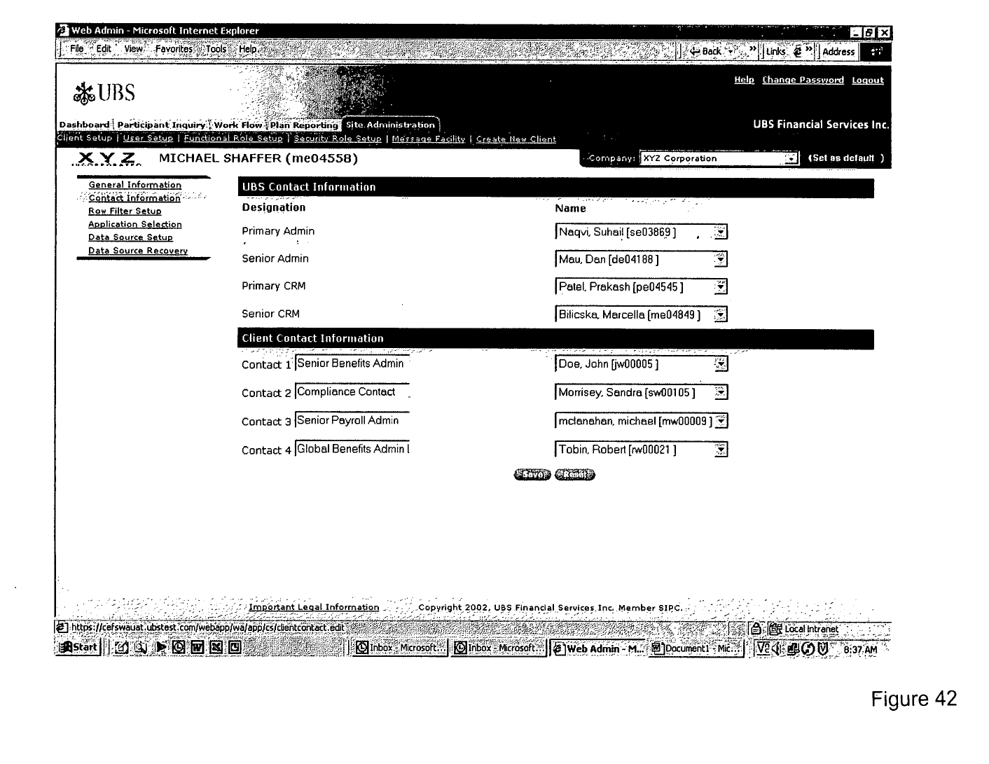

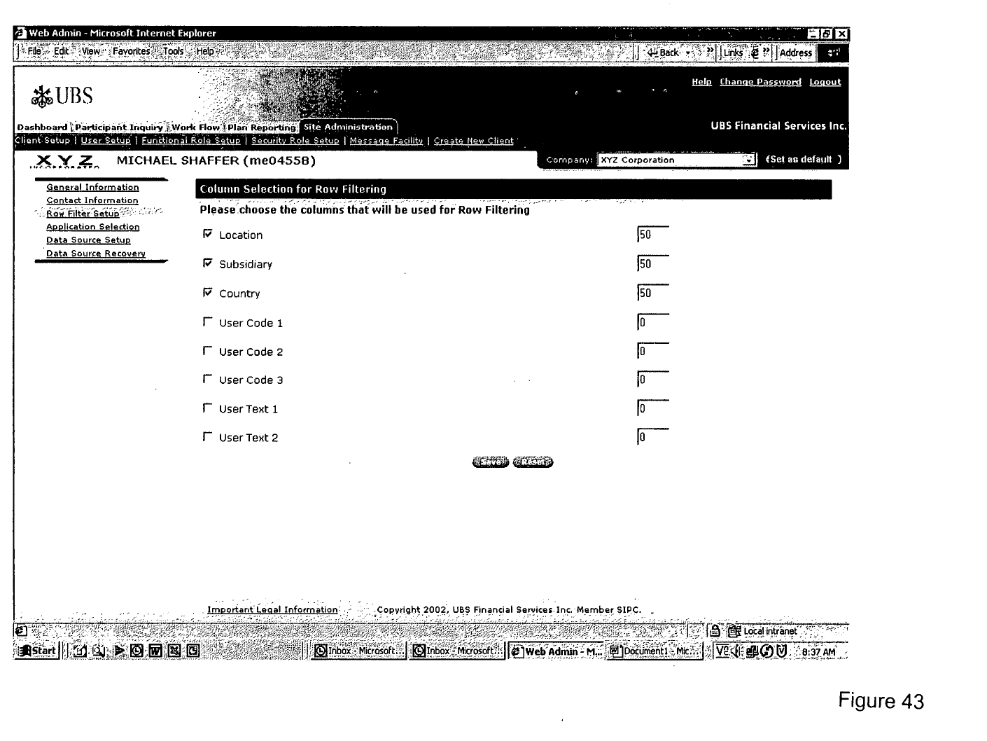

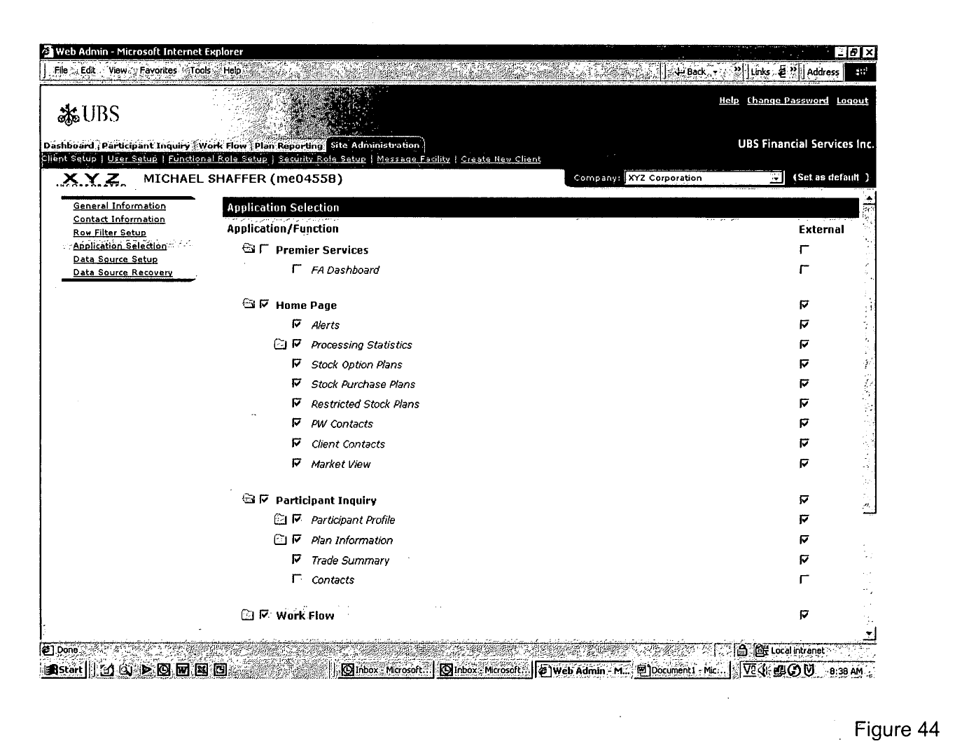

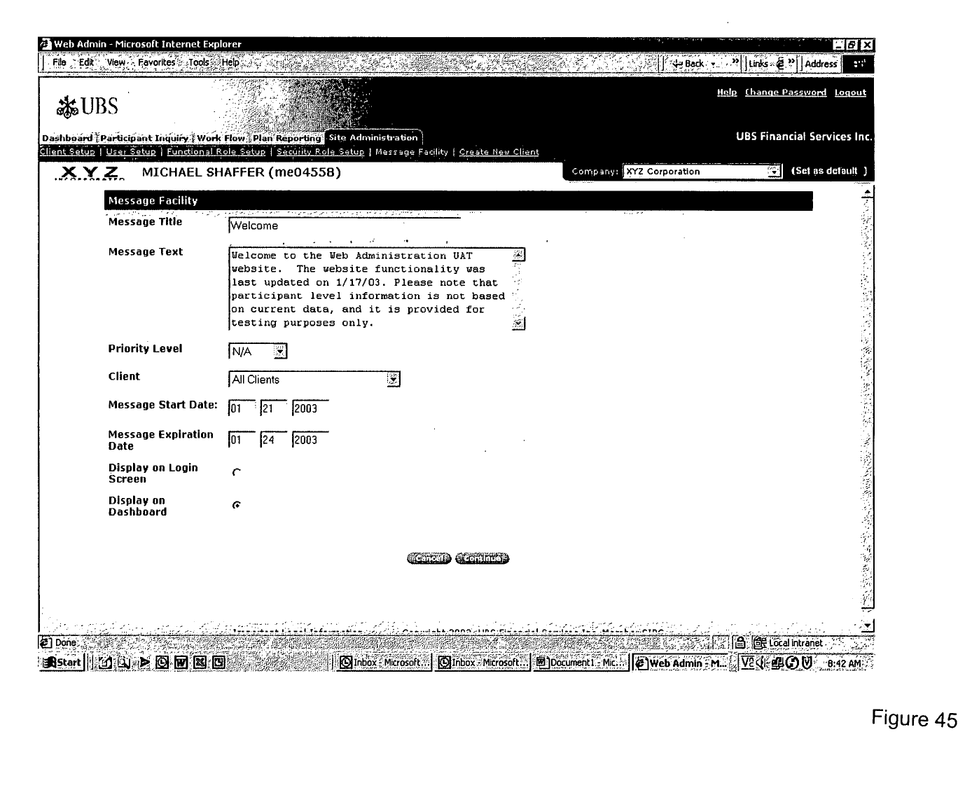

In one embodiment, site administration interface screen includes therein navigation elements, such as hyperlinks displayed in the form of sub-tabs, allowing a user to navigate to related interface screens, as shown in FIGS. 37-45, and therewith allow the user to request a user setup, a functional role setup, a security role setup, or a client setup. In response to requests for a user setup, step 3706, a functional role setup, step 3716, a security role setup, step 3722, or a client setup, step 3728, a corresponding interface screen is displayed or caused to be displayed, steps 3710, 3720, 3726, 3732. The respective interface screens include therein form elements allowing a user to communicate the particular request to the system. Setup data received by the system, step 3712, is used to create a profile for a new user or client, or to update existing user or client profiles, step 3714.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for providing centralized employee stock plan administration, comprising:
receiving identification information from a user;
determining the user's entitlement to available features based on the identification information; and
displaying an administrator's dashboard interface screen including therein an administrator's dashboard interface that provides at metrics according to the user's entitlement, the metric associated with at least one employee stock plan of a company, the metric providing users with key numerical data regarding at least one employee stock plan.

2. The method of claim 1, comprising displaying an administrator's dashboard interface providing at least one metric associated with at least one employee stock plan, the metric comprising at least one of processing statistics for workflow requests, processing statistics for reporting requests, plan activity for particular employee stock plans, and plan statistics for particular stock plans.

3. The method of claim 2, wherein the plan activity metric comprises data pertaining to at least one of the number of shares of company stock exercised, vested, expired, settled, and released, and wherein the plan statistics comprises data pertaining to at least one of the number of active participants, outstanding grants, outstanding options, outstanding plan value, outstanding shares, and total elections.

4. The method of claim 1, comprising displaying an administrator's dashboard interface providing the user with at least one feature selected from a group consisting of alerts, contact information, and market information.

5. The method of claim 1, comprising determining, based on the identification information, the user's company specific entitlement to available features.

6. The method of claim 1, comprising displaying an administrator's dashboard interface screen including therein at least one of a plurality of available key business function navigation elements displayed according to user's entitlements, the key business function navigation elements allowing users to access therewith key business functions.

7. The method of claim 6, wherein the key business function navigation elements are displayed consistently within each of the key business function interface screens.

8. The method of claim 8, wherein the key business navigation elements allows users to access key business functions comprising at least one of an administrator's dashboard function, a participant inquiry function, a workflow function, a reporting function, a site administration function, a file exchange function, a client profile function, and an events calendar function.

9. The method of claim 8, comprising:
displaying a participant inquiry interface screen in response to a user's navigation request, the participant inquiry interface screen including form elements therein allowing the user to specify search criteria to search for participants of at least one employee stock plan;
receiving therewith the search criteria from the user; and
displaying a search result interface screen listing participants matching the user's search criteria, the search result interface screen including at least one navigation element therein allowing the user to access participant information for a particular participant.

10. The method of claim 9, comprising:
receiving a request for a participant profile for a particular participant; and
displaying a participant profile interface screen in response thereto, the participant profile interface screen providing personal information relating to the participant, and including therein navigation elements allowing a user to access at least one of administration data, comments, registration data, leave of absence data, participant plan information, and trade summaries for the selected participant.

11. The method of claim 8, comprising displaying a workflow interface screen in response to a user's navigation request, the workflow interface screen providing a status summary for workflow requests.

12. The method of claim 11, comprising displaying a workflow interface screen including therein form elements allowing a user to specify search criteria to search for workflow requests;
receiving therewith search criteria from the user; and
displaying a search result interface screen listing workflow requests matching the user's search criteria, the search result interface screen including at least one navigation element therein allowing the user to access a case summary for a particular workflow request.

13. The method of claim 11, comprising displaying a workflow interface screen in response to a user's navigation request, the workflow interface screen providing a status summary for workflow requests submitted by all users assigned a specific role.

14. The method of claim 11, comprising:
displaying a workflow interface screen including form elements therein allowing a user to submit a particular type of a new workflow request;
receiving a new workflow request; and
displaying a new workflow request interface screen particular to the type of workflow request received, the workflow request interface screen including form elements therein allowing the user to specify details of the request.

15. The method of claim 14, wherein the workflow interface screen includes therein a participant ID form element requiring the user to input a participant's identification number in order to initiate a new workflow request for a participant, the form elements included in the new workflow request interface screen automatically populated based on the participant's identification number.

16. The method of claim 14, comprising displaying a workflow interface screen including form elements therein allowing a user to submit a particular type of new workflow request selected from a group consisting of a general change request for a participant, a request for a participant demographic change, a grant change request, a request to indicate participant termination, a request for a participant tax profile change, a request for an exercise revision, a request to block users from the system, and a request to change insider status.

17. The method of claim 11, the workflow interface screen including therein at least one navigation element associated with a particular workflow requests listed therein allowing the user to request a workflow case summary.

18. The method of claim 8, comprising displaying a plan reporting interface screen in response to a user's navigation request, the plan reporting interface screen allowing the user to request a report based on at least one of user defined criteria and a report template of a plurality of available templates, and allowing the user to view reports.

19. The method of claim 18, wherein the plan reporting interface screen includes therein navigation elements allowing a user to navigate to an interface screen selected from a group consisting of a run report interface screen allowing a user to request a report therewith, a report queue interface screen proving a list of active, pending, scheduled, and failed reports, and a finished report interface screen listing reports that the user is entitled to view, the finished report interface screen including navigation elements therein allowing the user to request an action with respect to the listed reports.

20. A method for providing centralized employee stock plan administration, comprising:
receiving identification information from a user;
determining the user's entitlement to available features based on the identification information; and
displaying an administrator's dashboard interface screen including therein an administrator's dashboard interface that provides at least one metric according to user entitlement, the metric associated with at least one employee stock plan of a company, the metric comprising at least one metric selected from the group consisting of processing statistics for workflow requests, processing statistics for reporting requests, plan activity for particular employee stock plans, and plan statistics for particular stock plans, the administrator's dashboard interface providing the user with at least one feature selected from the group consisting of alerts, contact information, and market information, the administrator's dashboard interface including a plurality of key business function navigation elements displayed according to user's entitlements allowing the user to access key business functions selected from the group consisting of an administrator's dashboard function, a participant inquiry function, a workflow function, a reporting function, a site administration function, a file exchange function, a client profile function, and an events calendar function.

21. A method of providing centralized employee stock plan administration comprising:
displaying a participant inquiry interface screen in response to a user's navigation request, the participant inquiry interface screen including form elements therein allowing a user to specify search criteria to search participants of at least one employee stock plan;
receiving therewith search criteria from the user;
displaying a search result interface screen listing participants matching the user's search criteria, the search result interface screen including at least one navigation element therein allowing the user to access participant information for a particular participant;
receiving a request for a participant profile for a particular participant; and
displaying a participant profile interface screen in response thereto, the participant profile interface screen providing personal information relating to the participant, and including therein navigation elements allowing the user to access at least one of administration data, comments, registration data, leave of absence data, participant plan information, and trade summaries for the selected participant.

22. A method of providing centralized employee stock plan administration comprising:
displaying a workflow interface screen in response to a user's navigation request, the workflow interface screen providing a status summary for workflow requests, the workflow interface screen including therein form elements therein allowing a user to submit a particular type of new workflow request selected from a group consisting of a general change request for a participant, a request for a participant demographic change, a grant change request, a request to indicate participant termination, a request for a participant tax profile change, a request for an exercise revision, a request to block users from the system, and a request to change insider status;
receiving a new workflow request; and
displaying a new workflow request interface screen particular to the type of workflow request received, the workflow request interface screen including form elements therein allowing the user to specify details of the request.

23. A method of providing centralized employee stock plan administration comprising:
displaying a plan reporting interface screen in response to a user's navigation request, the plan reporting interface screen allowing a user to request a report based on at least one of user defined criteria and a report template of a plurality of available templates, and allowing the user to view reports, the plan reporting interface screen including therein navigation elements allowing a user to navigate to an interface screen selected from the group consisting of a run report interface screen allowing a user to request a report therewith, a report queue interface screen proving a list of active, scheduled, and completed reports, and a finished report interface screen listing reports that the user is entitled to view, the finished report interface screen including navigation elements therein allowing the user to request an action with respect to the listed reports.

24. A system for providing centralized employee stock plan administration comprising at least one server computer connected over a communication network to at least one client device, the at least one server computer including application programming, the system therewith capable of:
receiving identification information from a user;
determining the user's entitlement to available features provided by the system based on the identification information; and
displaying an administrator's dashboard interface screen including therein an administrator's dashboard interface that provides at least one metric according to the user's entitlement, the metric associated with at least one employee stock plan of a company, the metrics providing users with key numerical data regarding at least one employee stock plan.

25. The system of claim 24, wherein the server computer is capable of displaying an administrator's dashboard interface providing at least one metric associated with at least one employee stock plan, the metric comprising at least one of processing statistics for workflow requests, processing statistics for reporting requests, plan activity for particular employee stock plans, and plan statistics for particular stock plans.

26. The system of claim 25, wherein the plan activity metric comprises data pertaining to at least one of the number of shares of company stock exercised, vested, expired, settled, and released, and wherein the plan statistics comprises data pertaining to at least one of the number of active participants, outstanding grants, outstanding options, outstanding plan value, outstanding shares, and total elections.

27. The system of claim 24, wherein the server computer is capable of displaying an administrator's dashboard interface providing the user with at least one feature selected from the group consisting of alerts, contact information, and market information.

28. The system of claim 24, wherein the server computer is capable of determining, based on the identification information, the user's company specific entitlement to available features.

29. The system of claim 24, wherein the server computer is capable of displaying an administrator's dashboard interface screen including therein at least one of a plurality of available key business function navigation elements displayed according to user's entitlements, the key business function navigation elements allowing users to access therewith key business functions.

30. The system of claim 29, wherein the key business function navigation elements are displayed consistently within each of the key business function interface screens.

31. The system of claim 29, wherein the key business navigation elements allows users to access key business functions comprising at least one of an administrator's dashboard function, a participant inquiry function, a workflow function, a reporting function, a site administration function, a file exchange function, a client profile function, and an events calendar function.

32. The system of claim 32, the server computer capable of:
displaying a participant inquiry interface screen in response to a user's navigation request, the participant inquiry interface screen including form elements therein allowing the user to specify search criteria to search for participants of at least one employee stock plan;
receiving therewith the search criteria from the user; and
displaying a search result interface screen listing participants matching the user's search criteria, the search result interface screen including at least one navigation element therein allowing the user to access participant information for a particular participant.

33. The system of claim 32, the server computer capable of:
receiving a request for a participant profile for a particular participant; and
displaying a participant profile interface screen in response thereto, the participant profile interface screen providing personal information relating to the participant, and including therein navigation elements allowing a user to access at least one of administration data, comments, registration data, leave of absence data, participant plan information, and trade summaries for the selected participant.

34. The system of claim 31, the server capable of displaying a workflow interface screen in response to a user's navigation request, the workflow interface screen providing a status summary for workflow requests.

35. The system of claim 34, the server capable of displaying a workflow interface screen including therein form elements allowing a user to specify search criteria to search workflow requests;
receiving therewith search criteria from the user; and
displaying a search result interface screen listing workflow requests matching the user's search criteria, the search result interface screen including at least one navigation element therein allowing the user to access a case summary for a particular workflow request.

36. The method of claim 34, the server capable of displaying a workflow interface screen in response to a user's navigation request, the workflow interface screen providing a status summary for workflow requests submitted by all users assigned a specific role.

37. The system of claim 34, the server capable of:
displaying a workflow interface screen including form elements therein allowing a user to submit a particular type of a new workflow request;
receiving a new workflow request; and
displaying a new workflow request interface screen particular to the type of workflow request received, the workflow request interface screen including form elements therein allowing the user to specify details of the request.

38. The system of claim 37, wherein the workflow interface screen includes therein a participant ID form element requiring the user to input a participant's identification number in order to initiate a new workflow request for a participant, the form elements included in the new workflow request interface screen automatically populated based on the participant's identification number.

39. The system of claim 37, the server capable of displaying a workflow interface screen including form elements therein allowing a user to submit a particular type of a new workflow request selected from a group consisting of a general change request for a participant, a request for a participant demographic change, a grant change request, a request to indicate participant termination, a request for a participant tax profile change, a request for an exercise revision, a request to block users from the system, and a request to change insider status.

40. The system of claim 34, the workflow interface screen including therein at least one navigation element allowing the user to request a workflow case summary.

41. The system of claim 31, the server capable of displaying a plan reporting interface screen in response to a user's navigation request, the plan reporting interface screen allowing the user to request a report based on at least one of user defined criteria and a report template of a plurality of available templates, and allowing the user to view reports.

42. The system of claim 41, wherein the plan reporting interface screen includes therein navigation elements allowing a user to navigate to an interface screen selected from the group consisting of a run report interface screen allowing a user to request a report therewith, a report queue interface screen proving a list of active, scheduled, and completed reports, and a finished report interface screen listing reports that the user is entitled to view, the finished report interface screen including navigation elements therein allowing the user to request an action with respect to the listed reports.

43. A system for providing centralized employee stock plan administration comprising at least one server computer connected over a communication network to at least one client device, the at least one server computer including application programming, the system therewith capable of:
receiving identification information from a user;
determining the user's entitlement to available features based on the identification information; and
displaying an administrator's dashboard interface screen including therein an administrator's dashboard interface that provides at least one metric according to user entitlement, the metric associated with at least one employee stock plan of a company, the metric comprising at least one metric selected from the group consisting of processing statistics for workflow requests, processing statistics for reporting requests, plan activity for particular employee stock plans, and plan statistics for particular stock plans, the administrator's dashboard interface providing the user with at least one feature selected from the group consisting of alerts, contact information, and market information, the administrator's dashboard interface including a plurality of key business function navigation elements displayed according to user's entitlements allowing the user to access key business functions selected from the group consisting of an administrator's dashboard function, a participant inquiry function, a workflow function, a reporting function, a site administration function, a file exchange function, a client profile function, and an events calendar function.

44. A system for providing centralized employee stock plan administration comprising at least one server computer connected over a communication network to at least one client device, the at least one server computer including application programming, the system therewith capable of:
displaying a participant inquiry interface screen in response to a user's navigation request, the participant inquiry interface screen including form elements therein allowing a user to specify search criteria to search participants of at least one employee stock plan;
receiving therewith search criteria from the user;
displaying a search result interface screen listing participants matching the user's search criteria, the search result interface screen including at least one navigation element therein allowing the user to access participant information for a particular participant;
receiving a request for a participant profile for a particular participant; and
displaying a participant profile interface screen in response thereto, the participant profile interface screen providing personal information relating to the participant, and including therein navigation elements allowing the user to access at least one of administration data, comments, registration data, leave of absence data, participant plan information, and trade summaries for the selected participant.

45. A system for providing centralized employee stock plan administration comprising at least one server computer connected over a communication network to at least one client device, the at least one server computer including application programming, the system therewith capable of:
displaying a workflow interface screen in response to a user's navigation request, the workflow interface screen providing a status summary for workflow requests, the workflow interface screen including therein form elements therein allowing a user to submit a particular type of new workflow request selected from a group consisting of a general change request for a participant, a request for a participant demographic change, a grant change request, a request to indicate participant termination, a request for a participant tax profile change, a request for an exercise revision, a request to block users from the system, and a request to change insider status;
receiving a new workflow request; and
displaying a new workflow request interface screen particular to the type of workflow request received, the workflow request interface screen including form elements therein allowing the user to specify details of the request.

46. A system for providing centralized employee stock plan administration comprising at least one server computer connected over a communication network to at least one client device, the at least one server computer including application programming, the system therewith capable of:
displaying a plan reporting interface screen in response to a user's navigation request, the plan reporting interface screen allowing a user to request a report based on at least one of user defined criteria and a report template of a plurality of available templates, and allowing the user to view reports, the plan reporting interface screen including therein navigation elements allowing a user to navigate to an interface screen selected from the group consisting of a run report interface screen allowing a user to request a report therewith, a report queue interface screen proving a list of active, scheduled, and completed reports, and a finished report interface screen listing reports that the user is entitled to view, the finished report interface screen including navigation elements therein allowing the user to request an action with respect to the listed reports.
